(19) United States
(12) Patent Application Publication
(10) Pub. No.: US 2026/0073625 A1
(43) Pub. Date: Mar. 12, 2026

(54) IMAGE PROCESSING APPARATUS AND OPERATING METHOD THEREOF

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Daesung CHO, Suwon-si (KR); Sungkil Lee, Suwon-si (KR); Seungho Park, Suwon-si (KR); Jaein Park, Suwon-si (KR); Younghoon Jeong, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 19/331,304

(22) Filed: Sep. 17, 2025

Related U.S. Application Data
(63) Continuation of application No. PCT/KR2025/013825, filed on Sep. 5, 2025.

(30) Foreign Application Priority Data
Sep. 9, 2024 (KR) 10-2024-0122582

(51) Int. Cl. G06T 15/20; G06T 3/40; G06T 5/20; G06T 5/50; G06T 5/70; G06T 7/13; G06T 7/55

(52) U.S. Cl. CPC G06T 15/205; G06T 3/40; G06T 5/20; G06T 5/50; G06T 5/70; G06T 7/13; G06T 7/55; G06T 2207/20216

(57) ABSTRACT

An image processing apparatus includes: at least one processor including processing circuitry; and memory including one or more storage media storing one or more instructions, where the at least one processor is configured to, individually or collectively, execute the one or more instructions to cause the image processing apparatus to: obtain an input depth map from a two-dimensional (2D) input image, the input depth map including a boundary region and a non-boundary region of an object, perform first filtering on a first frame and a previous frame of the input depth map to obtain a first filtered depth map, by applying different weights to the boundary region and the non-boundary region, and generate a three-dimensional (3D) image, based on the first filtered depth map and the 2D input image.

### CROSS-REFERENCE TO RELATED APPLICATION(S)

This application is a continuation of International Application No. PCT/KR2025/013825, filed on Sep. 5, 2025, in the Korean Intellectual Property Receiving Office, which is based on and claims priority to Korean Patent Application No. 10-2024-0122582, filed on Sep. 9, 2024, in the Korean Intellectual Property Office, the disclosures of which are incorporated by reference herein in their entireties.

### BACKGROUND

### 1. Field

The disclosure relates to an image processing apparatus and an operating method of the image processing apparatus, and more particularly, to an image processing apparatus and an operating method of the image processing apparatus, which generate depth information from a two-dimensional (2D) image and generate a three-dimensional (3D) image.

### 2. Description of Related Art

A three-dimensional (3D) image allows people to three-dimensionally perceive the image by providing physical factors to stimulate people's visual senses in the same way as a real object based on a technology that applies depth information to a two-dimensional (2D) image to express a more realistic image. The 3D image is a form of the 2D image with distance information (or depth information) with respect to a subject (or object). The depth information is stored in the form of a depth map including depth values for respective pixels or respective blocks.

To generate a 3D image from a 2D image, research has been conducted into an image-based depth estimation technology. The image-based depth estimation technology is a technology that may analyze a 2D image, measure a distance between an imaging device and a subject, and generate a depth map based on the measured distance. Recently, with development of deep learning, it is possible to measure a distance from an image of an object taken with a single camera and generate a depth map based on deep learning. This may be referred to as a single image depth estimation method.

A method of expressing a 3D image by using a depth map is a depth image-based rendering (DIBR) method. The DIBR is a technology that may receive one color image and a depth image as input and generate a plurality of color images with different viewpoints (e.g., left eye and right eye).

Although the depth estimation method using deep learning has an advantage of being able to generate a depth map by using only an image taken by a single camera, the accuracy of the method is lower than that of measuring a distance by using a sensor such as a 3D camera or a light detection and ranging (LiDAR) sensor. Due to this, there are limits in detecting a subtle depth change in an object within an image. Thus, when a 3D image is generated through a depth map that does not reflect a depth change of an object, a 3D effect of the 3D image may be degraded.

### SUMMARY

Aspects will be set forth in part in the description which follows and, in part, will be apparent from the description, or may be learned by practice of the presented embodiments.

According to an aspect of the disclosure, an image processing apparatus may include: at least one processor including processing circuitry; and memory including one or more storage media storing one or more instructions, where the at least one processor is configured to, individually or collectively, execute the one or more instructions to cause the image processing apparatus to: obtain an input depth map from a two-dimensional (2D) input image, the input depth map including a boundary region and a non-boundary region of an object. The at least one processor is configured to, individually or collectively, execute the one or more instructions to cause the image processing apparatus to perform first filtering on a first frame and a previous frame of the input depth map to obtain a first filtered depth map, by applying different weights to the boundary region and the non-boundary region. The at least one processor is configured to, individually or collectively, execute the one or more instructions to cause the image processing apparatus to generate a three-dimensional (3D) image, based on the first filtered depth map and the 2D input image.

According to an aspect of the disclosure, an operating method of an image processing apparatus may include: obtaining an input depth map from a two-dimensional (2D) input image, the input depth map including a boundary region and a non-boundary region of an object; performing first filtering on a first frame and a previous frame of the input depth map to obtain a first filtered depth map, by applying different weights to the boundary region and the non-boundary region; and generating a three-dimensional (3D) image, based on the first filtered depth map and the 2D input image.

According to an aspect of the disclosure, a computer-readable recording medium having recorded thereon a program for performing an operating method of on a computer, where the method includes: obtaining an input depth map from a two-dimensional (2D) input image, the input depth map including a boundary region and a non-boundary region of an object; performing first filtering on a first frame and a previous frame of the input depth map to obtain a first filtered depth map, by applying different weights to the boundary region and the non-boundary region; and generating a three-dimensional (3D) image, based on the first filtered depth map and the 2D input image.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for explaining an operation of generating a three-dimensional (3D) image from a two-dimensional (2D) image by an image processing apparatus according to an embodiment of the disclosure;

FIG. 2 is a diagram for explaining a 2D image, an input depth map corresponding to the 2D image, and a filtered depth map, according to an embodiment of the disclosure;

FIG. 3 is a block diagram of an image processing apparatus for generating a 3D image by using a depth map of a 2D image, according to an embodiment of the disclosure;

FIG. 4 is a detailed block diagram of a first filtering module of an image processing apparatus according to an embodiment of the disclosure;

FIG. 5 shows an example of a depth map including a moving object in neighboring frames according to an embodiment of the disclosure;

FIG. 6 shows an example of depth information obtained by an image processing apparatus through a boundary region detection module according to an embodiment of the disclosure;

FIG. 7 is a graph showing a weight used for first filtering, which is obtained through a weight generation module by an image processing apparatus according to an embodiment of the disclosure;

FIG. 8A shows an example of a depth map to which global infinite impulse response (IIR) filtering is applied according to an embodiment of the disclosure;

FIG. 8B shows an example of a depth map to which local IIR filtering is applied according to an embodiment of the disclosure;

FIG. 9 is a diagram for explaining an operation of obtaining an output depth map in an input depth map by an image processing apparatus through a first filtering module according to an embodiment of the disclosure;

FIG. 10 is a detailed block diagram of a second filtering module of an image processing apparatus according to an embodiment of the disclosure;

FIG. 11 is a diagram for explaining a blur effect applied to a foreground region and a background region of depth maps used in a maximum value calculation module according to an embodiment of the disclosure;

FIG. 12 is a graph showing a depth value by region of depth maps used in a maximum value calculation module according to an embodiment of the disclosure;

FIG. 13 is a detailed block diagram of a second filtering module of an image processing apparatus according to an embodiment of the disclosure;

FIG. 14 is a diagram for explaining an operation of obtaining an output depth map in an input depth map by an image processing apparatus through a second filtering module according to an embodiment of the disclosure;

FIG. 15 is a diagram for explaining a depth map blur processing module according to an embodiment of the disclosure;

FIG. 16 is a flowchart illustrating a method, performed by an image processing apparatus, of generating a 3D image by performing first filtering on a depth map according to an embodiment of the disclosure;

FIG. 17 is a flowchart illustrating a method, performed by an image processing apparatus, of generating a 3D image by performing second filtering on a depth map according to an embodiment of the disclosure;

FIG. 18 is a flowchart for explaining an operating method of an image processing apparatus according to an embodiment of the disclosure;

FIG. 19 is a diagram for explaining an operation, performed by an image processing apparatus, of filtering an input depth map through a first filtering module and a second filtering module according to an embodiment of the disclosure; and

FIG. 20 is a block diagram of an image processing apparatus according to an embodiment of the disclosure.

### DETAILED DESCRIPTION

In the disclosure, the expression “at least one of a, b or c” may refer to “a”, “b”, “c”, “a and b”, “a and c”, “b and c”, “all of a, b and c”, or variations thereof.

Hereinafter, an embodiment of the disclosure is described in detail such that those of skill in the art may easily implement the same with reference to the accompanying drawings. However, the disclosure may be implemented in various different forms and is not limited to the embodiment described herein.

The terms used in this disclosure are described as currently used general terms in consideration of the functions mentioned in the disclosure, but these may mean various other terms depending on the intention of those of skill in the art, precedents, emergence of new technologies, and the like. Therefore, the terms used in the disclosure should not be interpreted solely based on the names of the terms, but should be interpreted based on the meanings of the terms and the overall contents of the disclosure.

The term used in the disclosure is for the purpose of describing a particular embodiment only and is not intended to limit the disclosure.

In the specification, when it is described that a certain portion is “connected” to another portion, it should be understood that the certain portion may be directly connected to another portion or electrically connected to another portion via another portion in the middle.

As used in this specification, particularly in the claims, “a” or “the” and similar indicators may refer to both the singular and the plural. The operations of all methods described herein may be performed in any suitable order unless otherwise indicated herein or otherwise clearly contradicted by context. The disclosure is not limited to the described order of the operations.

Phrases such as “in some embodiments” or “in an embodiment” in various places in this specification do not necessarily all refer to the same embodiment.

Some embodiments of the disclosure may be described in terms of functional block components and various processing operations. Some or all of these functional blocks may be implemented in various numbers of hardware and/or software configurations that perform specific functions. For example, the functional blocks of the disclosure may be implemented by one or more microprocessors, or may be implemented by circuit configurations for certain functions. For example, functional blocks of the disclosure may be implemented in various programming or scripting languages. Functional blocks may be implemented as algorithms executed by one or more processors. The disclosure may employ existing technologies for electronic environment setup, signal processing, and/or data processing. Terms such as “mechanism,” “element,” “means,” and “configuration” may be used broadly and are not limited to mechanical and physical components.

The connecting lines, or connectors shown in the drawings presented are intended to represent exemplary functional relationships and/or physical or logical couplings between the various elements. Many alternative or additional functional relationships, physical connections or logical connections, may be present in a practical device.

The terms such as “ . . . unit” or “module” disclosed in the specification mean units for processing at least one function or operation, which may be implemented by hardware, software, or a combination thereof.

In the disclosure, a “processor” may include various processing circuits and/or a plurality of processors. For example, the term “processor” as used herein, including the claims, may include various processing circuits, including at least one processor. At least one processor, and one or more processors may be configured to individually and/or collectively perform the various functions described herein in a distributed manner. As used herein, “processor,” “at least one processor,” and “one or more processors” may be configured to perform a variety of functions. However, these terms cover, without limitation, situations in which one processor performs some of the functions and other processor(s) perform other parts of the functions, and situations in which a single processor may perform all of the functions. At least one processor may include a combination of processors that perform various functions of the disclosed functions in a distributed manner. At least one processor may execute program instructions to accomplish or perform various functions.

In the disclosure, the term “user” means a person who uses a display device, and may include a consumer, an evaluator, a viewer, an administrator, or an installer. The term “manufacturer” or “provider” in the specification may mean a manufacturer that manufactures a display device and/or components included in the display device.

In the disclosure, an ‘image’ may include a still image, a graphic, a picture, a frame, a moving image including a plurality of consecutive still images, or a video.

In the disclosure, a ‘neural network’ is a representative example of an artificial neural network model that simulates brain nerves, and is not limited to an artificial neural network model using a specific algorithm. The neural network may also be referred to as a deep neural network.

The disclosure will be described in detail with reference to the attached drawings below.

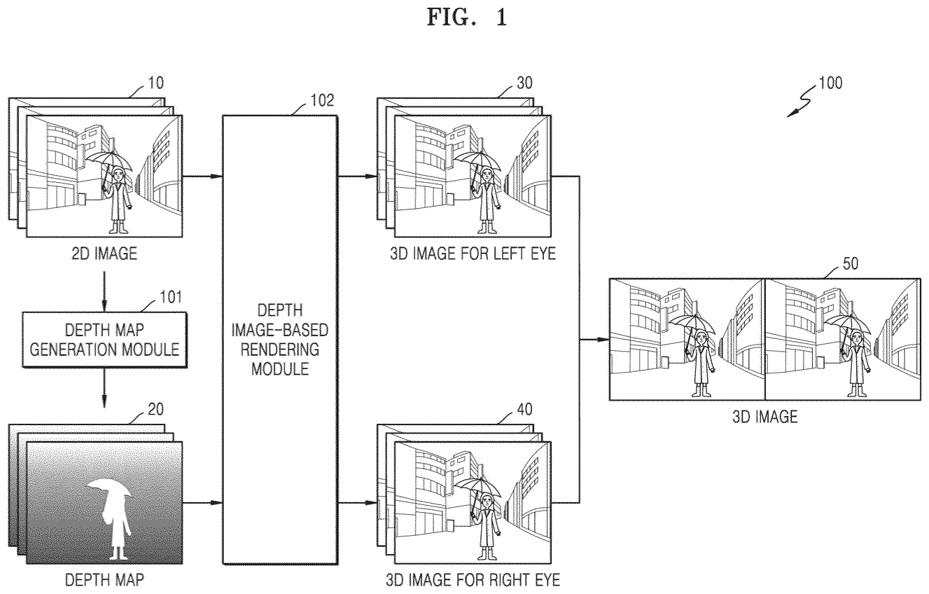

FIG. 1 is a diagram for explaining an operation of generating a three-dimensional (3D) image from a two-dimensional (2D) image by an image processing apparatus according to an embodiment of the disclosure.

Referring to FIG. 1, an image processing apparatus 100 according to an embodiment of the disclosure may be an apparatus that converts a 2D image into a 3D image (or stereoscopic image).

The image processing apparatus 100 according to an embodiment of the disclosure may be an apparatus that receives 2D image signals received from various image input sources and converts the signals into a 3D image before displaying the signals. Here, the image processing apparatus 100 may be implemented in a form that is mounted on a display device such as a television (TV) or a monitor or may be implemented as a separate device such as a set-top box and implemented in a form that is linked with the display device. When the image processing apparatus 100 is implemented in a form mounted on the display device, the image processing apparatus 100 may display the converted 3D image in a stereoscopic or auto-stereoscopic manner.

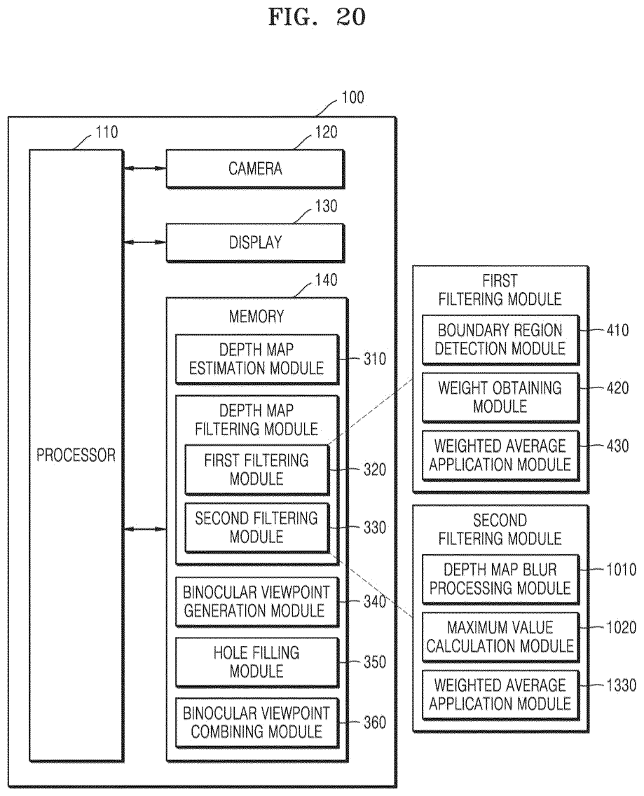

The image processing apparatus 100 according to an embodiment of the disclosure may include a depth map generation module 101 and a depth image-based rendering module 102. However, not all of the components shown are required. The image processing apparatus 100 may be implemented with more components than the illustrated components or may be implemented with fewer components. Detailed components of the image processing apparatus 100 will be described in detail with reference to FIG. 20. The depth map generation module 101 and the depth image-based rendering module 102 may be provided in the memory of the image processing apparatus 100 and implemented as software such as instructions, an algorithm, a data structure, or a program code executed by the processor of the image processing apparatus 100.

The image processing apparatus 100 according to an embodiment of the disclosure may generate a depth map 20 from a 2D image 10 through the depth map generation module 101. The image processing apparatus 100 may analyze the 2D image 10, measure a distance between an imaging device and a subject (or object), and generate the depth map 20 based on the measured distance. The image processing apparatus 100 may estimate a depth value for each pixel within each frame of the input 2D image 10. The depth map 20 may include a depth value between a subject located in a 3D space and an imaging device that captures the subject. The depth map 20 may include depth values for respective pixels existing in each frame of the 2D image 10. Each frame of the depth map 20 may correspond to each frame of the 2D image 10. The depth map 20 may be expressed in the form of a depth image in which a depth value for an object is represented in units of black and white. For example, the depth map 20 may express objects at a close distance in dark colors and objects at a far distance in bright colors.

The depth map generation module 101 of the image processing apparatus 100 according to an embodiment of the disclosure may include a depth map estimation model implemented by deep learning, the depth map estimation model may measure a distance from an image obtained by capturing a subject by a single camera and generate the depth map 20.

The image processing apparatus 100 according to an embodiment of the disclosure may receive the 2D image 10 and the depth map 20 through the depth image-based rendering module 102 and generate a plurality of 3D images having different viewpoints. For example, the plurality of 3D images may include a 3D image for left eye 30 and a 3D image for right eye 40. The image processing apparatus 100 may generate a virtual viewpoint image by projecting or warping an image of one viewpoint into an image of another viewpoint by using the 2D image 10 and the depth map 20.

The image processing apparatus 100 according to an embodiment of the disclosure may generate a 3D image 50 obtained based on a combination of the left and right eyes (i.e., a binocular 3D image) based on the 3D image for left eye 30 and the 3D image for right eye 40. For example, the 3D image 50 has a side-by-side format in which the 3D image for left eye 30 and the 3D image for right eye 40 are arranged side by side in one frame, but is not limited thereto. For example, in the 3D image 50 in a side-by-side format, the 3D image for left eye 30 and the 3D image for right eye 40, which have an original resolution of 1920×1080, may each be reduced to 960×1080 and arranged left and right.

As described above, the image processing apparatus 100 according to an embodiment of the disclosure may use the depth map 20 to generate a 3D image (e.g., 30, 40, or 50). The depth map 20 may include a moving object, and in this case, the less a residual image appears at a boundary of a moving object existing in the depth map 20, the more a 3D effect of the 3D image may be improved. The more accurately a subtle depth change inside an object included in the depth map 20 is reflected, the more a 3D effect of the 3D image may be improved.

The image processing apparatus 100 according to an embodiment of the disclosure may perform filtering on a depth map to improve a 3D effect of the 3D image. For example, the image processing apparatus 100 may generate an input depth map from the 2D image 10 and perform filtering on the input depth map. In the filtered depth map according to an embodiment of the disclosure, there may be less residual image at an object boundary due to movement of the object, and a depth change inside the object may be accurately reflected.

Hereinafter, an operation in which the image processing apparatus 100 performs filtering on the input depth map to generate a depth map for improving a 3D effect of a 3D image is described.

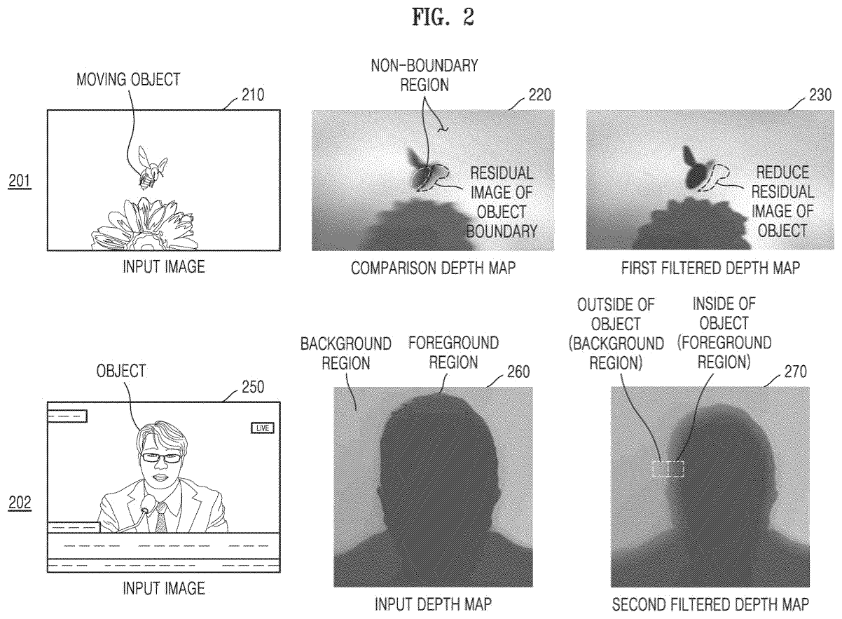

FIG. 2 is a diagram for explaining a 2D image, a depth map corresponding to the 2D image, and a filtered depth map, according to an embodiment of the disclosure.

Referring to 201 of FIG. 2, a 2D image 210, a comparison depth map 220, and a first filtered depth map 230 are described.

The 2D image 210 may include an object with a lot of movement. When there is a lot of object movement, flicker between frames may occur in the input depth map generated from the 2D image 210. For example, when the input depth map is generated from the 2D image 210 through the depth map estimation model, the input depth map may have a non-uniform depth value for each frame depending on the accuracy of the depth map estimation model. In this case, flicker between frames or frame flicker may occur in the input depth map. To reduce flicker between frames, inter-frame smoothing filtering may be applied. For example, the inter-frame smoothing filtering may be a method of removing flicker between frames through a weighted average of a current frame (e.g., a “first frame”) and a previous frame. In the disclosure, the inter-frame smoothing filtering may correspond to infinite impulse response (IIR) filtering.

However, in the comparison depth map 220 that is weighted-averaged using a global weight (a fixed weight in an entire region), a residual image remains at a boundary of objects, and thus a 3D effect of a moving object is degraded.

In an embodiment of the disclosure, the image processing apparatus 100 may perform filtering on the input depth map to generate the first filtered depth map 230. In the first filtered depth map 230, flicker between frames may be reduced and a residual image at a boundary of moving objects may be reduced. Here, filtering to reduce flicker between frames and reduce a residual image at the boundary of moving objects in the input depth map may be referred to as first filtering or filtering for enhancing inter-frame 3D effect.

In an embodiment of the disclosure, the image processing apparatus 100 may generate a depth map having uniform depth values between frames through the first filtering. For example, the image processing apparatus 100 may perform the first filtering by using a variable weight (e.g., a weight having different values in a boundary region and a non-boundary region), thereby applying different weighted averages to the boundary region and the non-boundary region of an object, which will be described below.

Referring to 202 of FIG. 2, a 2D image 250, an input depth map 260 corresponding to the 2D image 250, and a second filtered depth map 270 are described.

The 2D image 250 may include a foreground and a background, and in this case, an object may be located in the foreground and the background may be located further away than the object in the foreground.

The input depth map 260 generated from the 2D image 250 may have a small difference between depth values that constitute an object (e.g., a human face) located in the foreground. When local features on a surface of an object have similar depth values overall, a 3D effect of the object may be reduced and the object may appear flat, which may be unnatural.

In an embodiment of the disclosure, the image processing apparatus 100 may perform filtering on the input depth map 260 to generate the second filtered depth map 270, in which subtle depth changes of an object are reflected and a boundary between the object (e.g., inside of the object) and the outside of the object is clearly distinguished. Here, the subtle depth changes of the object are reflected in the input depth map, and the filtering for distinguishing a boundary between the object and the outside of the object may be referred to as second filtering or filtering for enhancing a 3D effect of an object boundary.

In an embodiment of the disclosure, the image processing apparatus 100 may generate a depth map in which subtle depth changes of an object are reflected and a difference in depth values based on a boundary between the object and the outside of the object is accurately reflected through the second filtering. For example, the image processing apparatus 100 may apply different blur processing to a foreground region and a background region through the second filtering, which will be described below.

An operation of performing filtering on an input depth map according to an embodiment of the disclosure may overcome limitations, in particular, of a depth map estimation model that estimates a depth map by using only an image obtained by capturing a subject by a single camera (e.g., limitations in that the precision of the depth map is lower than that of a 3D camera or LiDAR method). Accordingly, the image processing apparatus 100 may increase depth map accuracy by reducing a residual image of the object boundary in the input depth map through first filtering and accurately reflecting the depth change inside the object through second filtering.

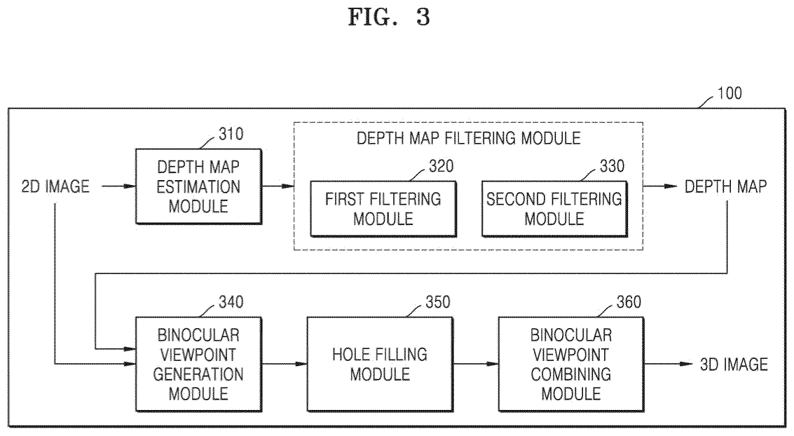

FIG. 3 is a block diagram of an image processing apparatus for generating a 3D image by using a depth map of a 2D image, according to an embodiment of the disclosure.

Referring to FIG. 3, the image processing apparatus 100 according to an embodiment of the disclosure may include a depth map estimation module 310, a depth map filtering module (e.g., a first filtering module 320, and a second filtering module 330), a binocular viewpoint generation module 340, a hole filling module 350, and a binocular viewpoint combining module 360. However, not all of the components shown are required. The image processing apparatus 100 may be implemented with more components than the illustrated components or may be implemented with fewer components. The depth map estimation module 310, the first filtering module 320, the second filtering module 330, the binocular viewpoint generation module 340, the hole filling module 350, and the binocular viewpoint combining module 360 may be provided in the memory of the image processing apparatus 100 and may be implemented as software such as instructions, an algorithm, a data structure, or a program code executed by the processor of the image processing apparatus 100.

Here, the depth map generation module 101 of FIG. 1 may include the depth map estimation module 310, the first filtering module 320, and the second filtering module 330. The depth image-based rendering module 102 of FIG. 1 may include the binocular viewpoint generation module 340, the hole filling module 350, and the binocular viewpoint combining module 360. However, the disclosure is not limited thereto.

The depth map estimation module 310 may generate a depth map from a 2D image. In an embodiment of the disclosure, the depth map estimation module 310 may be a neural network trained to output a depth map from the 2D image. The neural network may receive a 2D color image (e.g., an RGB image) and output a depth map. The depth map may be stored as a one-channel image with a depth value corresponding to each pixel of a 2D color image. The depth map may be configured with depth values from 0.0 to 1.0 through a normalization process. For example, a closest distance may be represented as 0.0 and may be represented by a dark color in the depth map. For example, a furthest distance may be represented as 1.0 and may be represented by a bright color in the depth map. The depth map estimation module 310 may output an input depth map from a 2D image input to the image processing apparatus 100. Here, the neural network may be referred to as a depth map estimation model. However, the disclosure is not limited thereto, and the depth map estimation module 310 may be configured with instructions or program codes related to an operation or function of generating a depth map based on the 2D image.

The image processing apparatus 100 may input the input depth map output from the depth map estimation module 310 to at least one of the first filtering module 320 or the second filtering module 330 or input the input depth map to both the first filtering module 320 and the second filtering module 330. For example, the image processing apparatus 100 may perform first filtering on an image with a lot of movement. For example, the image processing apparatus 100 may perform second filtering on an image (e.g., a human face) for expressing depth changes of an object.

The first filtering module 320 may generate a first filtered depth map from the depth map input to the first filtering module 320. Here, the depth map input to the first filtering module 320 is exemplified as being the input depth map output from the depth map estimation module 310, but is not limited thereto. The first filtering module 320 may perform infinite impulse response (IIR) filtering to reduce flicker between frames for an image containing an object with a lot of movement. For example, the first filtering module 320 may perform local IIR filtering that performs a weighted average by using a variable weight that has different weights for each boundary region and non-boundary region. The accuracy of the depth map in the boundary region may be improved by reducing a residual image in the boundary region of the depth map through the first filtering module 320. The first filtered depth map may be a depth map with an enhanced 3D effect, with reduced flicker between frames and less residual images at object boundaries.

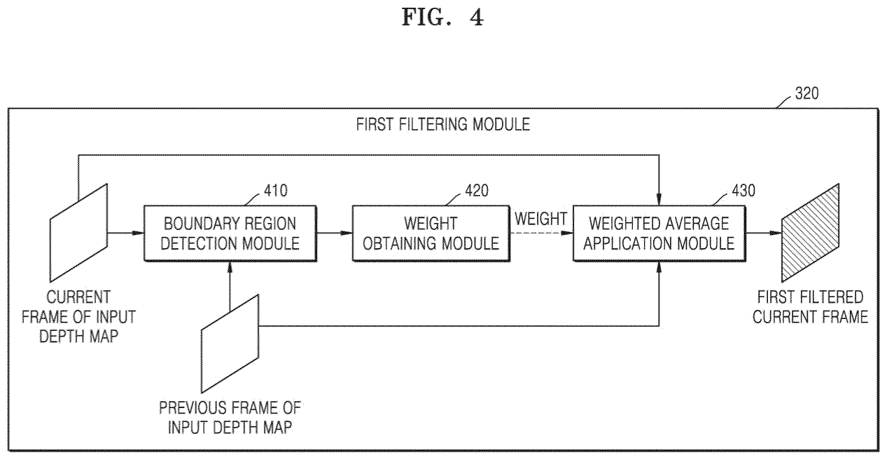

For example, the first filtering module 320 may include a boundary region detection module 410 (in FIG. 4) for detecting a boundary region of a moving object. The first filtering module 320 may include a weight obtaining module 420 (in FIG. 4) for obtaining a weight on which a weighted average is to be performed on a pixel-by-pixel basis differently for each region. The first filtering module 320 may include a weighted average application module 430 (in FIG. 4) that performs a weighted average on a pixel-by-pixel basis between the current frame and the previous frame of the input depth map. This is explained with reference to FIG. 4.

The second filtering module 330 may generate a second filtered depth map from the depth map input to the second filtering module 330. Here, the depth map input to the second filtering module 330 may be an input depth map output from the depth map estimation module 310 or a first filtered depth map output from the first filtering module 320. Hereinafter, to clearly explain an operation of the second filtering module 330, the depth map input to the second filtering module 330 is exemplified as an input depth map. The second filtering module 330 may implement depth changes inside an object by blur-processing the foreground region. The second filtering module 330 may generate a depth map to which blur processing is applied differently for the foreground region and the background region, thereby implementing depth changes within the object and distinguishing the boundary between the foreground region and the background region. The second filtered depth map may be a depth map with an enhanced 3D effect by implementing depth changes within the object and distinguishing the boundary between the foreground region and the background region.

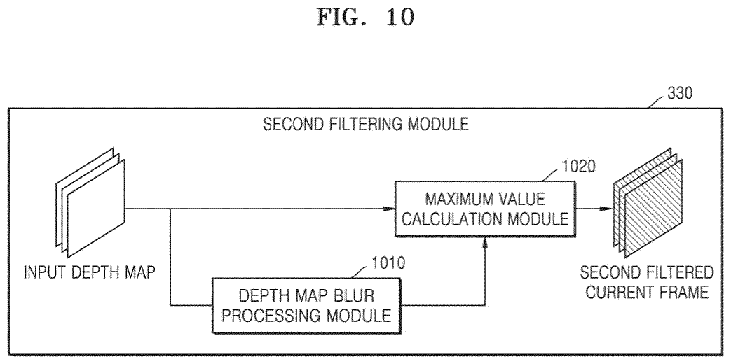

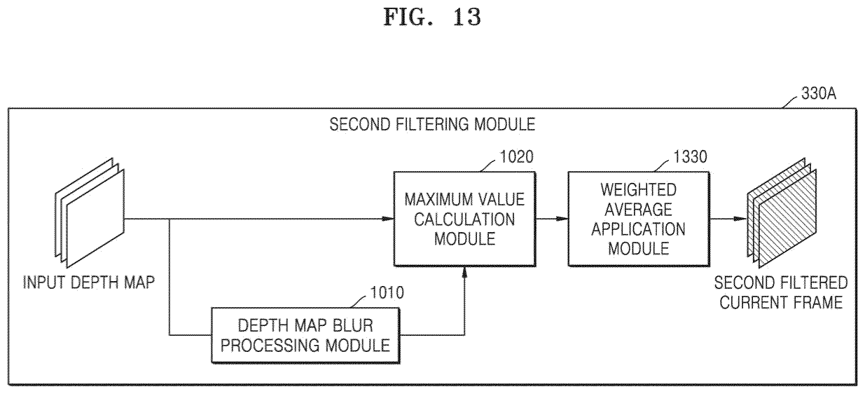

For example, the second filtering module 330 may include a depth map blur processing module 1010 (in FIG. 10) for blur processing the input depth map. A smooth boundary may be formed between the foreground region and the background region of the input depth map through the depth map blur processing module 1010. The second filtering module 330 may include a maximum value calculation module 1020 (in FIG. 10) that performs maximum value calculation to prevent a boundary between the foreground region and the background region from disappearing due to a decrease in the depth value of the background after blur processing. This is explained with reference to FIG. 10. The second filtering module 330 may include a weighted average application module 1330 (in FIG. 13) (or a mixed calculation module) that performs a weighted average on a pixel-by-pixel basis by using the input depth map as a weight to reflect less blur processing in the background region. The weighted average application module 1330 may prevent the boundaries of other objects located in the background region from disappearing during blur processing. This is explained with reference to FIG. 13.

The binocular viewpoint generation module 340 may generate a 3D image of a virtual viewpoint based on a depth map and 2D image input to the binocular viewpoint generation module 340. The 3D image of the virtual viewpoint may include, for example, a 3D image for left eye and a 3D image for right eye. The depth map input to the binocular viewpoint generation module 340 may include at least one of the first filtered depth map output from the first filtering module 320 or the second filtered depth map output from the second filtering module 330. For example, the binocular viewpoint generation module 340 may generate a 3D image for left eye by moving each pixel included in a 2D image to the left by a depth value. For example, the binocular viewpoint generation module 340 may generate a 3D image for right eye by moving each pixel included in a 2D image to the right by a depth value.

The hole filling module 350 may form an interpolation pixel within a hole by using pixels adjacent to the hole when the hole is generated within a frame as the pixels move. Here, the hole may mean a pixel for which no pixel value (e.g., RGB data) is input. The hole may be generated in a dis-occlusion region in which a pixel is occluded by an object and then re-appears as the pixel moves. The dis-occlusion region may not have information that is to be obtained from an original image when an image of a virtual viewpoint is generated. Non-existent information needs to be shown, and thus the dis-occlusion region may appear as an empty pixel or hole.

The binocular viewpoint combining module 360 may generate a 3D image by combining a 3D image for left eye and a 3D image for right eye. Depending on a method of combining left and right images into a 3D image, there are various methods including a top-down method in which an image for left eye and an image for right eye are placed vertically within a frame, a left-to-right (L-to-R) (or side-by-side) method in which the image for left eye and the image for right eye are placed horizontally within a frame, a checker board method in which pieces of the image for left eye and the image for right eye are placed in a tile shape, an interlaced method in which the image for left eye and the image for right eye are placed alternately in columns or rows, and a time sequential (frame by frame) method in which the image for left eye and the image for right eye are displayed alternately over time. For example, the binocular viewpoint combining module 360 may combine multiple input signals (e.g., the image for left eye and the image for right eye) into one output signal through a multiplexer. The generated 3D image may be displayed by a 3D display.

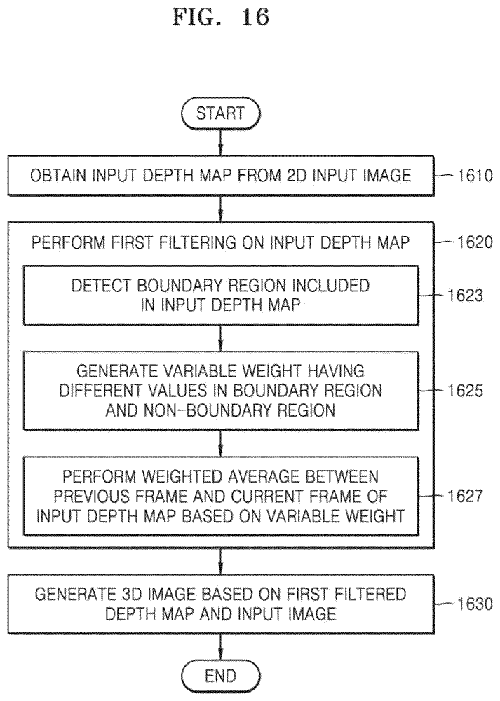

Hereinafter, the first filtering will be described with reference to FIGS. 4 to 9. The second filtering will be described with reference to FIGS. 10 to 15. Hereinafter, with reference to FIGS. 16 to 19, an operating method of the image processing apparatus 100 for processing an input depth map will be described.

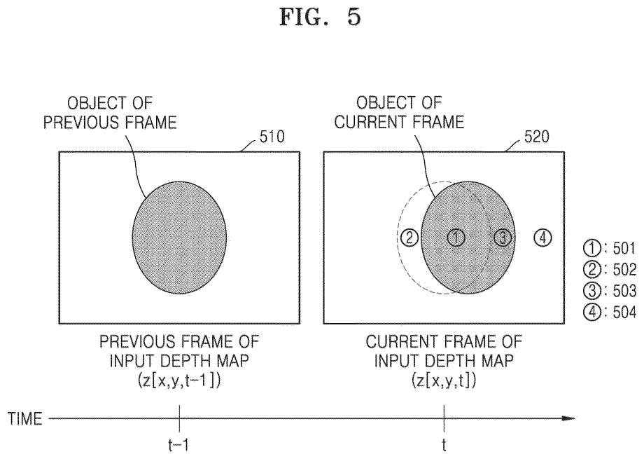

FIG. 4 is a detailed block diagram of a first filtering module of an image processing apparatus according to an embodiment of the disclosure. FIG. 5 shows an example of a depth map including a moving object in neighboring frames according to an embodiment of the disclosure.

Referring to FIG. 4, the first filtering module 320 may include a boundary region detection module 410, a weight obtaining module 420, and a weighted average application module 430. However, not all of the components shown are required. The first filtering module 320 may be implemented with more components than the illustrated components or may be implemented with fewer components. The boundary region detection module 410, the weight obtaining module 420, and the weighted average application module 430 may be provided in the memory of the image processing apparatus 100 and implemented as software such as instructions, an algorithm, a data structure, or a program code executed by the processor of the image processing apparatus 100.

Referring to FIG. 5, the input depth map input to the first filtering module 320 may include a moving object, and the position of the moving object may be different for each frame. For example, the input depth map may include a previous frame 510 at a first time point t-1 and a current frame 520 at a second time point t. The object included in the input depth map may move over time, and FIG. 5 illustrates an object moving to the right over time.

In the disclosure, the current frame 520 may be divided into a first region 501, a second region 502, a third region 503, and a fourth region 504 depending on movement of the object. Here, the first region 501 may represent an object region common to the current frame 520 and the previous frame 510. That is, the first region 501 may be a region in which depth information of an object in the current frame 520 and the previous frame 510 overlaps. The second region 502 may represent a dis-occlusion region that is behind the object in the previous frame 510 and then appears again as the object moves. The third region 503 may represent an occlusion region that is visible in the previous frame 510 and then is occluded due to movement of the object. The fourth region 504 may represent a background region other than the object common to the previous frame 510 and the current frame 520.

For example, in the current frame 520, the object in the previous frame 510 moves to the right, and thus the dis-occlusion region that was occluded by the object may be located to the left of the object. In the current frame 520, an occlusion region may be located to the right of the object that is present in the previous frame 510 and then is occluded as the object moves to the right.

In the disclosure, the boundary region of the object may be a region that changes as the object moves and may include the second region 502 and the third region 503. The non-boundary region of the object may be a region other than the boundary region and may include the first region 501 and the fourth region 504.

As described in 201 of FIG. 2, in an embodiment of the disclosure, depending on the accuracy (or performance) of the depth map estimation model, the input depth map may have non-uniform depth values from frame to frame. For example, when the accuracy of the depth map estimation model is low, the depth values may be different even in the same region in the previous frame 510 and the current frame 520. For example, when a depth value of the background region of the previous frame 510 is estimated to be 1.0 and a depth value of the background region of the current frame 520 is estimated to be 0.9, flicker between consecutive frames is observed. Accordingly, the image processing apparatus 100 may perform IIR filtering (or infinite impulse response filtering) to weighted-average the depth map between frames to alleviate flicker between frames for the input depth map.

In the IIR filtering, an operation of adjusting the current output may be performed in consideration of past input and past output. For example, the first filtering module 320 may adjust a depth value of the current frame 520 by using the previous frame 510 and the current frame 520, which are consecutive neighboring frames. Here, the previous frame may be a pre-filtered frame. The first filtering module 320 may adjust a depth value for each pixel belonging to a frame, and thus may be referred to as pixel-by-pixel filtering.

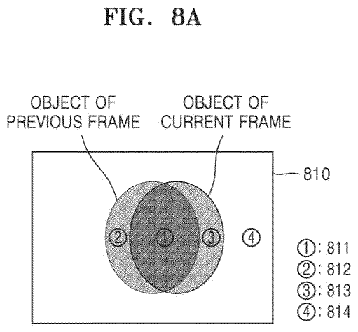

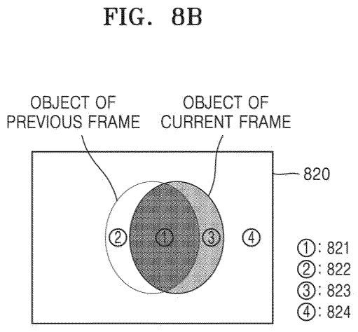

According to an embodiment of the disclosure, the first filtering module 320 may apply a weighted average with a variable weight, which may be referred to as local IIR filtering. The variable weight used in the local IIR filtering may be a weight that differs by region and may be referred to as a local weight. For example, the first filtering module 320 may apply different weighted averages to the boundary region and non-boundary region of the object when weighted-averaging the previous frame 510 and the current frame 520 of the depth map. Local filtering is more effective to reduce a residual image at boundaries of moving objects than global IIR filtering by using a global weight (i.e., a weight that is fixed over the entire region). This is further explained with reference to FIGS. 8A and 8B.

According to an embodiment of the disclosure, the first filtering module 320 may detect a boundary region included in an input depth map through the boundary region detection module 410. The first filtering module 320 may generate a variable weight having different values in the boundary region and non-boundary region through the weight obtaining module 420. The first filtering module 320 may apply a weighted average between the previous frame 510 and the current frame 520 of the input depth map based on the variable weight through the weighted average application module 430.

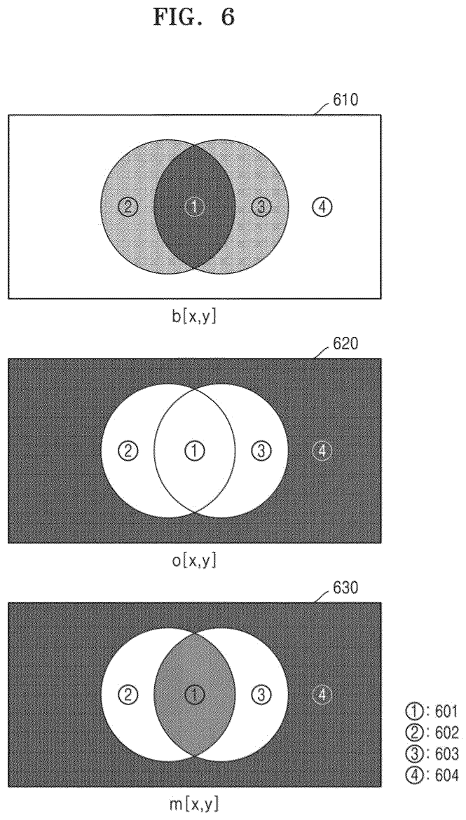

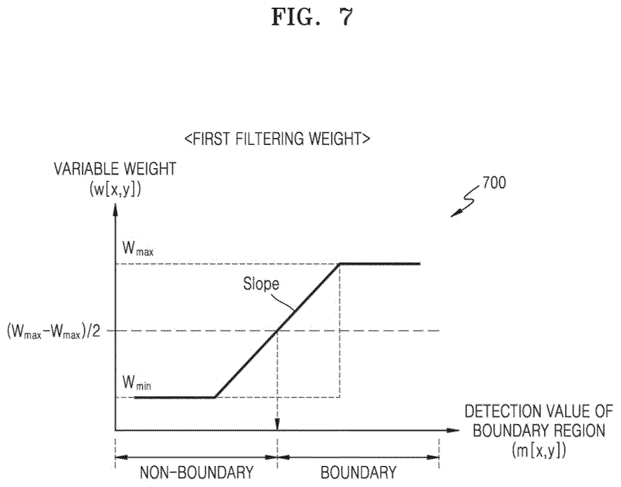

The operation of detecting the boundary region included in the input depth map through the boundary region detection module 410 is described with reference to FIG. 6, the operation of obtaining a variable weight through the weight obtaining module 420 is described with reference to FIG. 7, and the operation of generating a first filtered depth map through the weighted average application module 430 is described with reference to FIGS. 8A and 8B.

FIG. 6 shows an example of depth information obtained by an image processing apparatus through a boundary region detection module according to an embodiment of the disclosure. Here, depth information (e.g., 610, 620, and 630) obtained through the boundary region detection module 410 may be expressed in the form of a depth image. In the depth image, a large depth value may be represented as bright colors and a small depth value may be represented as dark colors.

The boundary region detection module 410 may detect the boundary region of a moving object. The boundary region detection module 410 may separately detect depth information of the boundary region and depth information of the non-boundary region.

The boundary region detection module 410 may obtain first depth information 610 based on the previous frame 510 and the current frame 520. The first depth information 610 may include depth information of the boundary region and a background region common to the previous frame 510 and the current frame 520. For example, the first depth information 610 may have a large depth value in a second region 602, a third region 603, and a fourth region 604 excluding a first region 601.

The first depth information 610 may be obtained through Equation 1.

$$b [ x , y ] = 1 - ( 1 - z [ x , y , t ] ) * ( 1 - z [ x , y , t - 1 ] ) \qquad [ Equation 1 ]$$

In Equation 1, z[x, y, t] represents depth information at position (x, y) of the current frame 520 of a depth map, and z[x, y, t−1] represents depth information at position (x, y) of the previous frame 510 of the depth map.

Equation 1 may calculate a result having large values in the second region 602, the third region 603, and the fourth region 604 through calculation of z[x,y,t−1] corresponding to the previous frame 510 and z[x,y,t] corresponding to the current frame 520 at position (x,y).

In Equation 1, 1−z[x,y,t] may have a large value in a foreground at position (x,y) of the current frame 520. For example, in 1−z[x,y, t], depth values of the first region 601 and the third region 603 may be greater than depth values of the second region 602 and the fourth region 604. The depth values of the first region 601 and the third region 603 may be similar to each other, and the depth values of the second region 602 and the fourth region 604 may be similar to each other. (That is, \textcircled{1}=\textcircled{3}>\textcircled{2}=\textcircled{4})

In Equation 1, 1−z[x,y,t−1] may have a large value in a foreground at position (x,y) of the previous frame 510. For example, in 1−z[x,y,t−1], the depth values of the first region 601 and the second region 602 may be greater than the depth values of the third region 603 and the fourth region 604. The depth values of the first region 601 and the second region 602 may be similar to each other, and the depth values of the third region 603 and the fourth region 604 may be similar to each other. (That is, \textcircled{1}=\textcircled{2}>\textcircled{3}=\textcircled{4})

In (1−z[x,y,t])*(1−z[x,y,t−1]) of Equation 1, the depth value of the first region 601 may be largest, the depth values of the second region 602 and the third region 603 may be similar to each other, and the depth value of the fourth region 604 may be smallest. (That is, \textcircled{1}>\textcircled{2}=\textcircled{3}>\textcircled{4})

In 1−(1−z[x,y,t])*(1−z[x,y,t−1]) of Equation 1, the depth value of the fourth region 604 may be largest, the depth values of the second region 602 and the third region 603 may be similar to each other, and the depth value of the first region 601 may be smallest. (That is, \textcircled{4}>\textcircled{2}=\textcircled{3}»\textcircled{1})

The boundary region detection module 410 may obtain second depth information 620 based on the previous frame 510 and the current frame 520. The second depth information 620 may have depth values of the foreground region of the previous frame 510 and the foreground region of the current frame 520. For example, the second depth information 620 may have large depth values in the first region 601, the second region 602, and the third region 603.

The second depth information 620 may be obtained through Equation 2.

$$o [ x , y ] = 1 - min ( z [ x , y , t - 1 ] , z [ x , y , t ] ) \qquad [ Equation 2 ]$$

Equation 2 may calculate a result having large values in the first region 601, the second region 602, and the third region 603 through calculation of z[x,y,t−1] representing depth information of position (x,y) of the previous frame 510 and z[x,y,t] representing depth information of position (x,y) of the current frame 520 at position (x,y).

In min (z[x,y,t−1], z[x,y,t]) of Equation 2, a large value in the fourth region 604 may be obtained. (That is, \textcircled{4}»\textcircled{1}=\textcircled{2}=\textcircled{3})

In 1-min (z[x,y,t−1], z[x,y,t]) of Equation 2, large values in the first region 601, the second region 602, and the third region 603 may be obtained. (That is, \textcircled{1}=\textcircled{2}=\textcircled{3}»\textcircled{4})

The boundary region detection module 410 may obtain third depth information 630 based on the first depth information 610 and the second depth information 620. The third depth information 630 may have a depth value of the boundary region. For example, the third depth information 630 may have large depth values in the second region 602 and the third region 603, and small depth values in the first region 601 and the fourth region 604.

The third depth information 630 may be obtained through Equation 3.

$$m [ x , y ] = b [ x , y ] * o [ x , y ] \qquad [ Equation 3 ]$$

Equation 3 may calculate a result having a large value in the boundary region by multiplying the result of Equation 1 and the result of Equation 2. (That is, \textcircled{2}=\textcircled{3}»\textcircled{1}>\textcircled{4})

The boundary region detection module 410 may transfer the third depth information 630, which is a detection result of the boundary region, to the weight obtaining module 420.

With reference to FIG. 7, an operation of the weight obtaining module 420 is further described. FIG. 7 is a graph showing a weight used for first filtering, which is obtained through a weight generation module by an image processing apparatus according to an embodiment of the disclosure. A graph 700 represents a boundary region detection value m[x,y] on the x-axis and a variable weight w[x,y] on the y-axis. The graph 700 shows a change in a variable weight according to boundary and non-boundary regions.

The weight obtaining module 420 may receive third depth information 730 from the boundary region detection module 410. The weight obtaining module 420 may obtain a weight for different weighted averages for respective regions. The weight may be a variable weight having different values for respective regions. The variable weight may be calculated on a pixel-by-pixel basis.

The variable weight may be obtained through Equation 4.

$$w [ x , y ] = clamp ( slope * m [ x , y ] , w min , w max ) \qquad [ Equation 4 ]$$

In Equation 4, clamp (x, minVal, maxVal) may be interpreted as min (max (x, minVal), maxVal), and a result value that limits the upper and lower limits may be calculated such that x satisfies minVal≤x≤maxVal. Here, slope*m[x,y] is a result of multiplying the third depth information 630 by a defined slope, and m[x,y] may be scaled according to the defined slope. Depending on the magnitude of the slope, whether a weight has a significant effect on a weighted average may be determined. w[x,y] represents a variable weight at position (x, y).

Referring to Equation 4 and the graph 700, a variable weight w[x, y] is a value obtained by scaling the third depth information with a defined slope, and the upper and lower limits may be limited to wmax and wmin, respectively. The variable weight w[x,y] may have a large value in a boundary region (e.g., the second region and the third region) and a small value in a non-boundary region (e.g., the first region and the fourth region). For example, in the boundary region, w[x,y]>(1−w[x,y]), and in the non-boundary region, w[x,y]≤(1−w[x,y]).

The weight obtaining module 420 may transfer the calculated variable weight to the weighted average application module 430.

With reference to FIGS. 8A and 8B, an operation of the weighted average application module 430 is further described. FIG. 8A illustrates an example of a depth map 810 to which global IIR filtering is applied, and FIG. 8B illustrates an example of a depth map 820 to which local IIR filtering is applied.

The weighted average application module 430 may receive a variable weight from the weight obtaining module 420 and receive the current frame 520 and previous frame 510 of the input depth map.

The weighted average application module 430 may apply a weighted average between the current frame 520 and the previous frame 510 of the input depth map based on the variable weight. The weighted average may be applied on a pixel-by-pixel basis. The weighted average application module 430 may generate the depth map 820 of the first filtered current frame by performing first filtering on the current frame 520. The depth map 820 of the first filtered current frame may correspond to the depth map to which local IIR filtering is applied.

The local IIR filtering may be performed using Equation 5 below.

$$z [ x , y , t ] = clamp ( z [ x , y , t - 1 ] * ( 1 - w [ x y ] ) + z [ x , y , t ] * w [ x , y ] , 0. , 1.0 ) \qquad [ Equation 5 ]$$

In Equation 5, the depth map of the current frame to which local IIR filtering is applied may be a result value obtained by performing a weighted average such that the depth map of the current frame 520 is reflected more in the boundary region and performing a weighted average such that the depth map of the previous frame 510 is reflected more in the non-boundary region. The upper and lower limits of the depth map may be 1 and 0, respectively.

In the boundary region, w[x,y]>(1−w[x,y]), and thus a depth value z[x,y,t] of position (x,y) of the current frame 520 may be reflected more than the depth value z[x,y,t−1] at position (x,y) of the previous frame 510.

In the non-boundary region, w[x,y]<(1−w[x,y]), and thus a depth value z[x,y,t−1] of position (x,y) of the previous frame 510 may be reflected more than or similarly to the depth value z[x,y,t] of position (x,y) of the current frame 520.

The local IIR filtered depth map of the current frame may be updated using Equation 6 below.

$$z [ x , y , t - 1 ] = z [ x , y , t ] \qquad [ Equation 6 ]$$

Through Equation 6, current frame information that is locally IIR filtered may be updated to the previous frame. Accordingly, the local IIR filtered current frame at the second time point t may be used as the previous frame, for local IIR filtering of a next frame at a third time point t+1.

The first filtering module 320 may perform first filtering on each frame of the input depth map, thereby generating the first filtered input depth map including a plurality of first filtered frames. The first filtering module 320 may output the first filtered input depth map.

The image processing apparatus 100 according to an embodiment of the disclosure may perform a variable weighted average such that the current frame is reflected more in an occlusion region and a dis-occlusion region and the previous frame is reflected more in other regions when weighted-averaging the previous frame and the current frame of the depth map.

Referring to FIG. 8A, the depth map 810 to which global IIR filtering is applied may be the result of performing a weighted average by applying a weight of 0.5:0.5 between the previous frame 510 and the current frame 520 (e.g., w[x, y]=0.5). The depth values of the previous frame 510 and the current frame 520 are reflected at the same ratio in the depth map 810, and thus a residual image may remain in a boundary region of an object (e.g., a second region 812 and a third region 813). For example, the second region 812 may not be updated as a background of the current frame 520 according to movement of the object but may be weighted-summed with a depth value corresponding to the foreground region of the previous frame 510 to remain as a residual image. For example, the third region 813 may not be updated as a foreground of the current frame 520 according to movement of the object but may be weighted-summed with a depth value corresponding to the background region of the previous frame 510 to remain as a residual image. For example, the second region 812 may be a background of the current frame 520 and the third region 813 may be a foreground of the current frame 520, but the second region 812 and the third region 813 may be configured with the same or similar depth values. A residual image may remain in the boundary region of the object, and thus the depth map 810 to which global IIR filtering is applied may have a degraded 3D stereoscopic effect.

The depth map 820 with local IIR filtering of FIG. 8B applied may be the result of performing a weighted average by applying a variable weight between the previous frame 510 and the current frame 520. The depth map 820 may perform a weighted average between the previous frame 510 and the current frame 520 in the boundary region of the object (e.g., a second region 822 and a third region 823), but may apply a greater weight to the current frame 520. For example, the third region 823 may be updated to a foreground of the current frame 520 according to movement of the object, and the second region 822 may be updated to a background of the current frame 520 according to movement of the object. For example, a depth value of the third region 823 corresponding to the background of the current frame 520 may be less than a depth value of the second region 822 corresponding to the foreground of the current frame 520. That is, the third region 823 may be expressed darker. Accordingly, the depth map 820 to which local IIR filtering is applied may remove a residual image in the boundary region and enhance 3D stereoscopic expression.

The depth map 820 may perform a weighted average between the previous frame 510 and the current frame 520 in the non-boundary region of the object (e.g., a first region 821 and a fourth region 824), but may apply a greater weight or a similar weight to the previous frame 510. Accordingly, a rapid depth change between frames may be reduced, preventing flicker between frames.

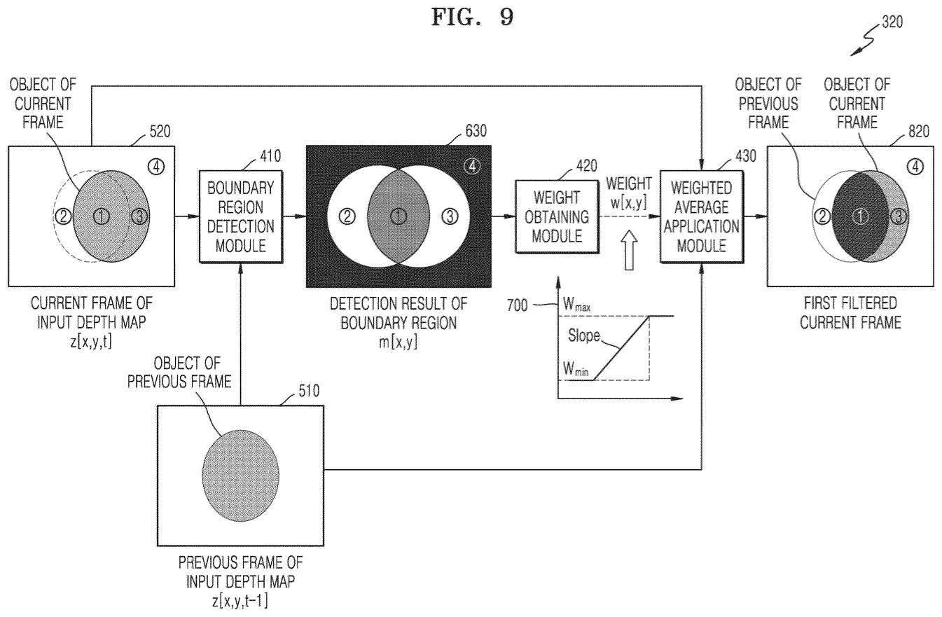

FIG. 9 is a diagram for explaining an operation of obtaining an output depth map in an input depth map by an image processing apparatus through a first filtering module according to an embodiment of the disclosure. Descriptions of terms are provided in FIGS. 4 to 8B.

Referring to FIG. 9, the image processing apparatus 100 may input the current frame 520 of the input depth map and the previous frame 510 of the input depth map to the boundary region detection module 410 to obtain the third depth information 630 corresponding to the boundary region detection result. The image processing apparatus 100 may input the third depth information 630 to the weight obtaining module 420 to obtain a weight. The weight may be a variable weight that has different weights in the boundary region and the non-boundary region as illustrated in the graph 700. The image processing apparatus 100 may obtain the current frame 520 of the input depth map, the previous frame 510 of the input depth map, and the variable weight to the weighted average application module 430 to obtain the depth map 820 of the first filtered current frame. The image processing apparatus 100 may update the previous frame to use the depth map 820 of the first filtered current frame as the previous frame for a first filtering process for a next frame. The image processing apparatus 100 may generate the first filtered depth map including a plurality of first filtered frames.

FIG. 10 is a detailed block diagram of a second filtering module of an image processing apparatus according to an embodiment of the disclosure.

Referring to FIG. 10, the second filtering module 330 may include the depth map blur processing module 1010 and a maximum value calculation module 1020. However, not all of the components shown are required. The second filtering module 330 may be implemented with more components than the illustrated components or may be implemented with fewer components. The depth map blur processing module 1010 and the maximum value calculation module 1020 may be provided in the memory of the image processing apparatus 100 and implemented as software such as instructions, an algorithm, a data structure, or a program code executed by the processor of the image processing apparatus 100.

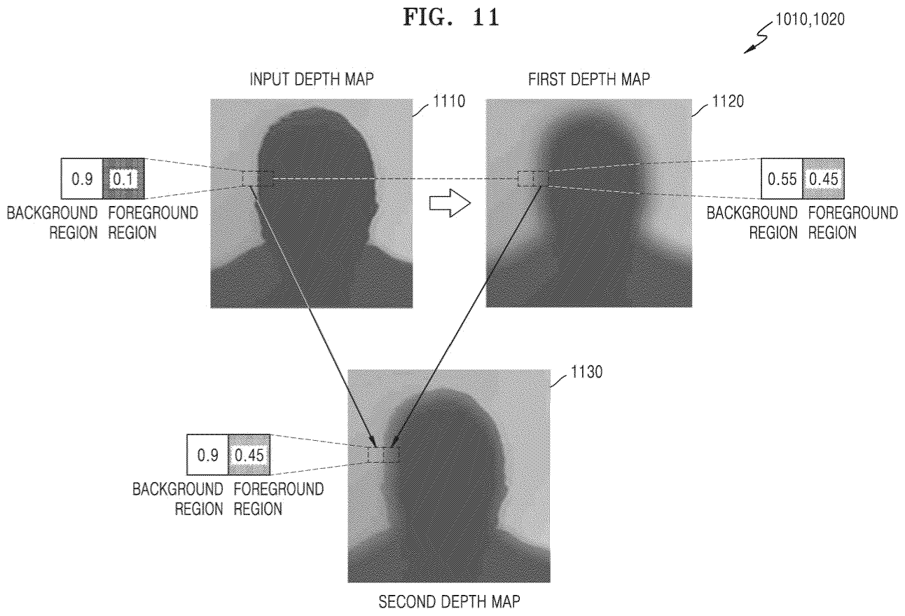

Hereinafter, with reference to depth maps illustrated in FIGS. 10 and 11, operations of the depth map blur processing module 1010 and the maximum value calculation module 1020 will be described in detail. FIG. 11 is a diagram for explaining a blur effect applied to a foreground region and a background region of depth maps used in a maximum value calculation module according to an embodiment of the disclosure.

Referring to FIGS. 10 and 11, the image processing apparatus 100 may input an input depth map 1110 into the depth map blur processing module 1010 to obtain a blur-processed depth map 1120. The blur-processed depth map 1120 may be referred to as a first depth map 1120. The image processing apparatus 100 may input an input depth map 1110 and the first depth map 1120 into the maximum value calculation module 1020 to obtain a second depth map 1130. Here, the input depth map 1110 may be an input depth map output from the depth map estimation module 310 or a first filtered depth map output from the first filtering module 320. Here, the second depth map 1130 may be a second filtered depth map.

The depth map blur processing module 1010 may perform blur processing on the input depth map 1110 to generate the first depth map 1120. The blur processing means making an image blurry by reducing the sharpness of the image and applying a soft blur effect. For example, when a depth map is blur-processed, a depth value in a background region may decrease and a depth value in a foreground region may increase. A soft boundary may be formed between the foreground region and the background region of the first depth map 1120.

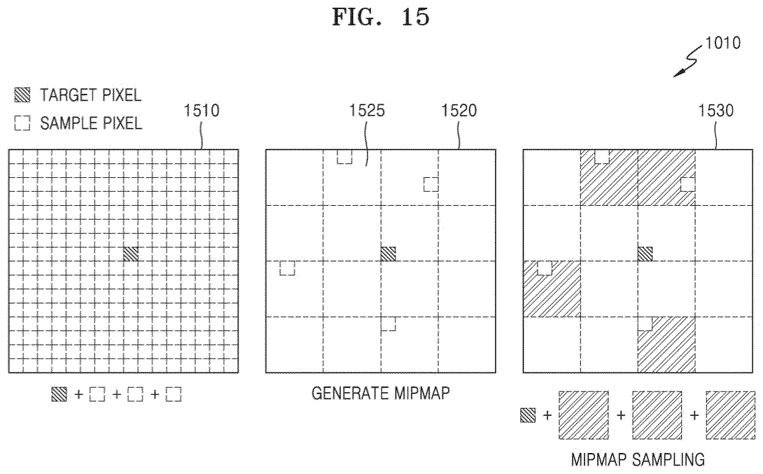

The depth map blur processing module 1010 may use a Gaussian filter, an average filter, a separable filter, or the like, but is not limited thereto. A detailed operation of the depth map blur processing module 1010 is described with reference to FIG. 15.

The maximum value calculation module 1020 may perform maximum value calculation between the input depth map 1110 and the first depth map 1120 to generate the second depth map 1130. The maximum value calculation module 1020 may obtain the second depth map 1130 through Equation 7.

$$e [ x , y ] = max ( z [ x , y ] , blur ( z [ x , y ] ) \qquad [ Equation 7 ]$$

In Equation 7, z[x,y] may represent a depth value of the input depth map 1110, and blur (z[x,y]) may represent the first depth map 1120, which is a blur-processed depth map. In Equation 7, depth values of the input depth map 1110 and the first depth map 1120 may be compared with each other and a larger value for each position (x, y) may be selectively reflected.

For example, in the foreground region, a depth value of the first depth map 1120 may be greater than a depth value of the input depth map 1110. In the background region, a depth value of the input depth map 1110 may be greater than a depth value of the first depth map 1120. Accordingly, the second depth map 1130 may have a foreground region in which the depth value of the first depth map 1120 is reflected and a background region in which the depth value of the input depth map 1110 is reflected. For example, the foreground region of the second depth map 1130 may have a depth value after blur processing, and the background region may have a depth value before blur processing.

The second depth map 1130 may have a blur-processed depth value in the foreground region, and thus a 3D effect of the foreground region may be emphasized. The second depth map 1130 may have a blur-processed depth value only in the foreground region, and thus a depth value of the background may be reduced after blur processing, preventing a boundary between the foreground region and the background region from disappearing.

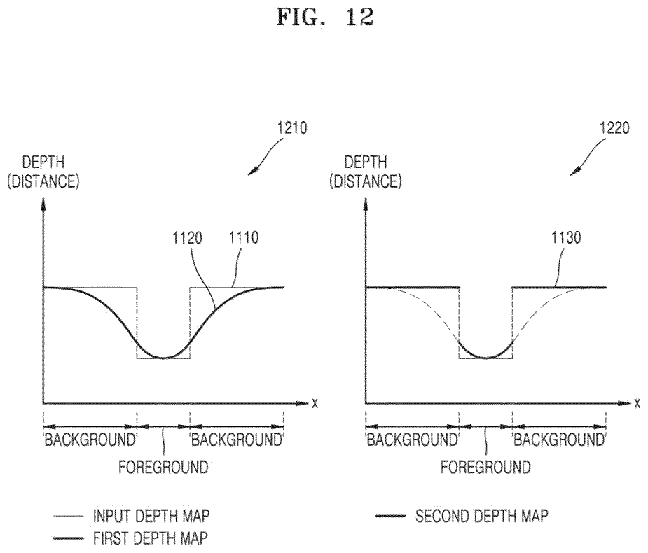

Hereinafter, with further reference to FIGS. 11 and 12, a boundary change between the foreground region and the background region is described. FIG. 12 is a graph showing a depth value by region of depth maps used in a maximum value calculation module according to an embodiment of the disclosure. Detailed depth values illustrated in FIG. 11 are merely examples for convenience of explanation and are not limited thereto. Graphs 1210 and 1220 represent x-coordinate positions on the x-axis and depth values on the y-axis. The graph 1210 shows a depth value of the input depth map 1110 and a change in depth value of the first depth map 1120 according to a background region and a foreground region. The graph 1220 shows a change in depth value of the second depth map 1130 according to the background region and the foreground region.

Referring to the graph 1210 of FIGS. 11 and 12, in the input depth map 1110, a boundary between the background region and the foreground region may be clearly distinguished. For example, at the boundary, a depth value of the background region may be 0.9, and a depth value of the foreground region may be 0.1.

The depth map blur processing module 1010 may receive the input depth map 1110 and output the first depth map 1120. When the depth map is blur-processed, the depth value of the foreground region of the first depth map 1120 may increase, and thus a 3D effect of the object may be improved. However, the first depth map 1120 is blur-processed, and thus a boundary between the background region and the foreground region may disappear. In particular, with respect to an object, a boundary between the inside and the outside of the object may not be distinguished, and a depth change may not appear. For example, at the boundary, a depth value of the background region may be 0.55, and a depth value of the foreground region may be 0.45.

Referring to the graph 1220 of FIG. 11 and FIG. 12, the maximum value calculation module 1020 may generate the second depth map 1130 including the background region in which a depth value of the input depth map 1110 is reflected and the foreground region in which the depth value of the first depth map 1120 is reflected. The foreground region of the second depth map 1130 may be identical to a depth value of the first depth map 1120. The background region of the second depth map 1130 may be identical to a depth value of the input depth map 1110.

The second depth map 1130 may clearly distinguish a boundary between the background region and the foreground region through maximum value calculation. In particular, a boundary between the inside of the object and the outside of the object may be distinguished based on the object. For example, at the boundary, a depth value of the background region may be 0.9, and a depth value of the foreground region may be 0.45. Accordingly, distortion of a background due to blur processing may be minimized.

The second depth map 1130 may include a blur-processed foreground region and a background region on which blur processing is not performed. By blur-processing the foreground region, a 3D effect inside the object may be improved. The background region is not blur-processed, and thus a boundary between the inside and outside of the object is clearly distinguished, and distortion of a background may be minimized.

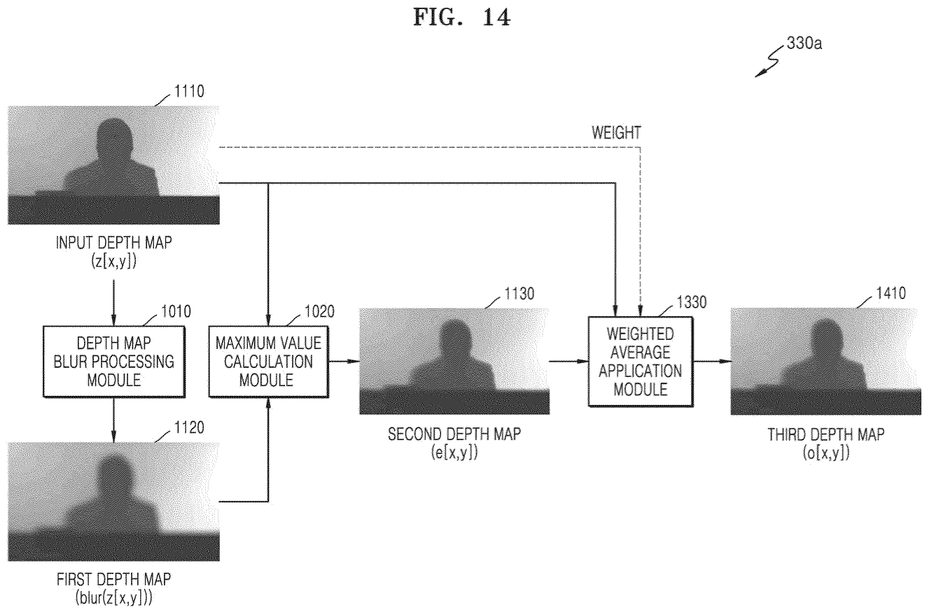

FIG. 13 is a detailed block diagram of a second filtering module of an image processing apparatus according to an embodiment of the disclosure. FIG. 14 is a diagram for explaining an operation of obtaining an output depth map in an input depth map by an image processing apparatus through a second filtering module according to an embodiment of the disclosure.

Referring to FIGS. 13 and 14, a second filtering module 330a may further include the weighted average application module 1330. The weighted average application module 1330 may be included in the memory of the image processing apparatus 100 and may be implemented as software such as instructions, an algorithm, a data structure, or a program code executed by the processor of the image processing apparatus 100.

The image processing apparatus 100 may input the input depth map 1110 and the second depth map 1130 to the weighted average application module 1330 to obtain a third depth map 1410. Here, the second depth map 1130 may be an intermediate depth map, and the third depth map 1410 may be a second filtered depth map (i.e., an output depth map).

The weighted average application module 1330 may perform mixed calculation in which the input depth map 1110 is applied at a mixing ratio. The mixed calculation may be identical to a process of performing a weighted average on the input depth map 1110 and the second depth map 1130 by applying the input depth map 1110 as a weight.

The weighted average application module 1330 may obtain the third depth map 1410 through Equation 8.

$$o [ x , y ] = mix ( e [ x , y ] , z [ x , y ] , z [ x , y ] ) = e [ x , y ] * ( 1 - z [ x , y ] ) + z [ x , y ] * z [ x , y ] \qquad [ Equation 8 ]$$

In Equation 8, mixed calculation in which the input depth map 1110 is applied at a mixing ratio may be performed between the input depth map 1110 and the second depth map 1130. Equation 8 may be interpreted identically to performing a weighted average on the input depth map 1110 and the second depth map 1130 but applying the input depth map 1110 as a weight.

The input depth map 1110 used as a variable weight may have a large value in the foreground region and a small value in the background region.

In the foreground region, z[x,y]<(1−z[x,y]), and thus a depth value e[x,y] at position (x,y) of the second depth map 1130 may be more significantly reflected than a depth value z[x,y] at position (x,y) of the input depth map 1110.

In the background region, z[x,y]>(1−z[x,y]), and thus a depth value z[x,y] at position (x,y) of the input depth map 1110 may be more significantly reflected than or similarly to a depth value e[x,y] at position (x,y) of the second depth map 1130.

The third depth map 1410 may be a result value obtained by performing a weighted average such that the second depth map 1130 is more reflected in the foreground region and performing a weighted average such that the input depth map 1110 is more reflected in the background region.

For example, the input depth map 1110 used as a weight has a large depth value (e.g., 1.0 or 0.9) in the background region, and thus the background region of the third depth map 1410 may be similar to the background region of the input depth map 1110. That is, the background region of the third depth map 1410 may not reflect blur processing like the input depth map 1110.

The third depth map 1410 may reflect blur processing in the foreground region and not reflect blur processing in the background region. Accordingly, when an object other than an object of interest (e.g., another object located behind a human face) is located in the background region, it may be possible to prevent a boundary from disappearing due to blur processing.

FIG. 15 is a diagram for explaining a depth map blur processing module according to an embodiment of the disclosure.

Referring to FIG. 15, the depth map blur processing module 1010 according to an embodiment of the disclosure may apply a blur effect by mixing a depth value of a target pixel of an input depth map with depth values of surrounding pixels of the target pixel.

The depth map blur processing module 1010 may include average filtering and Gaussian filtering. In the average filtering, an operation of calculating an average of depth values corresponding to the target pixel and surrounding pixels determined according to a sampling range may be performed. In the Gaussian filtering, an operation of applying a high weight to a pixel close to the target pixel and applying a low weight to a pixel far from the target pixel may be performed.

Here, the surrounding pixel referenced when performing blur processing on the target pixel may be referred to as a sample pixel. The sampling range represents a range of surrounding pixels referenced when performing blur processing, and may vary depending on a size of a blur filter, for example, 3×3 or 5×5. The number of sampled pixels may indicate the number of pixels actually referenced within the sampling range. For example, when the sampling range is 5×5, the number of sampleable pixels may be 24.

As exemplified in a depth map 1510, there may be cases in which the number of sampleable pixels is small compared to the sampling range. For example, when there are few surrounding pixels with depth values around the target pixel that requires blur processing, smooth blur processing may be difficult.

In this case, as exemplified in a depth map 1520, the depth map blur processing module 1010 may generate a mipmap in the form of an image pyramid of the depth map. The mipmap may be a block unit including a plurality of pixels. For example, the mipmap may contain a sample pixel and n pixels adjacent to the sample pixel. For example, the depth map blur processing module 1010 may calculate a depth value of the mipmap by averaging depth values of a plurality of pixels that constitute the mipmap.

As exemplified in a depth map 1530, the depth map blur processing module 1010 may instead sample the mipmap that is a higher level than the pixel. For example, the depth map blur processing module 1010 may perform blur processing on a target pixel by calculating an average of the depth values of the target pixel and plurality of mipmaps through average filtering. The image processing apparatus 100 may perform blur processing by using the mipmap, thereby applying a smooth blur effect by using a small number of sample pixels.

When blurring is applied to a depth map, an object may appear convex such that a depth near a boundary of the inside of the object is greater than a depth of the center of the object. However, a boundary between the foreground and background regions becomes ambiguous due to a blur effect, and thus an additional maximum value operation process may be performed to overcome this. The blur-processed depth map output from the depth map blur processing module 1010 may be transferred to the maximum value calculation module 1020 (in FIG. 10).

FIG. 16 is a flowchart illustrating a method, performed by an image processing apparatus, of generating a 3D image by performing first filtering on a depth map according to an embodiment of the disclosure. For convenience of explanation, FIG. 16 is explained with reference to FIGS. 4 to 9. In an embodiment of the disclosure, operations 1610 to 1630 may be performed by the image processing apparatus 100 or a processor of the image processing apparatus 100.

In operation 1610, the image processing apparatus 100 may obtain an input depth map from a 2D input image.

For example, the image processing apparatus 100 may obtain an input depth map from the 2D input image through the depth map estimation module 310 (in FIG. 3). When the depth map estimation module 310 (in FIG. 3) is implemented as a neural network trained to output a depth map from the 2D image, the neural network may receive a 2D color image (e.g., an RGB image) as input and estimate the depth map.

In operation 1620, the image processing apparatus 100 may perform first filtering on the input depth map. For example, the image processing apparatus 100 may perform first filtering on the input depth map through the first filtering module 320 (in FIG. 3). The first filtering may correspond to infinite impulse response (IIR) filtering to reduce flicker between frames for an image containing an object with a lot of movement. The IIR filtering may filter the depth map of the current frame by using the filtered depth map of the previous frame.

In more detail, the first filtering may correspond to local IIR filtering that performs a weighted average by using a variable weight that has different weights for each boundary region and non-boundary region of the input depth map. For example, the local IIR filtering may apply different weighted averages to the boundary region and non-boundary region of the object when weighted-averaging the previous frame and the current frame of the depth map. The local filtering is more effective to reduce a residual image at boundaries of moving objects than the global IIR filtering by using a global weight (e.g., a weight that is fixed over the entire region).

Here, the boundary region of the object may include, for consecutive frames, a dis-occlusion region that is behind the object in the previous frame and then appears again due to movement of the object, and an occlusion region that is visible in the previous frame and then becomes occluded due to movement of the object. The dis-occlusion region may be referred to as a second region, and the occlusion region may be referred to as a third region.

Here, the non-boundary region of the object may include, for consecutive frames, a first region, which is an object region common to the current frame and the previous frame, and a fourth region, which is a background region other than the object common to the previous frame and the current frame.

Operation 1620 may include operations 1623, 1625, and 1627.

In operation 1623, the image processing apparatus 100 may detect a boundary region included in the input depth map.

For example, the image processing apparatus 100 may detect the boundary region of a moving object within the input depth map through the boundary region detection module 410 (in FIG. 4). For example, the image processing apparatus 100 may obtain the first depth information 610 (in FIG. 6) having depth values of the boundary region (i.e., the second region and the third region) and the boundary region (i.e., the fourth region) based on the previous frame and the current frame through Equation 1. The image processing apparatus 100 may obtain the second depth information 620 (in FIG. 6) having depth values of the boundary region (i.e., the second region and the third region) and the foreground region (i.e., the first region) based on the previous frame and the current frame through Equation 2. The image processing apparatus 100 may obtain the third depth information 630 (in FIG. 6) having depth values of the boundary region (i.e., the second region and the third region) based on the first depth information 610 (in FIG. 6) and the second depth information 620 (in FIG. 6) through Equation 3.

In operation 1625, the image processing apparatus 100 may generate a variable weight having different values in the boundary region and the non-boundary region.

For example, the image processing apparatus 100 may obtain the variable weight having different values for respective regions through the weight obtaining module 420 (in FIG. 4).

For example, the image processing apparatus 100 may obtain the variable weight having different values in the boundary region and the non-boundary region by scaling the third depth information 630 (in FIG. 6) with a defined slope through Equation 4 and limiting an upper limit and a lower limit. The variable weight may have a large value in the boundary region and a small value in the non-boundary region. The variable weight is illustrated in a graph 700 of FIG. 7.

In operation 1627, the image processing apparatus 100 may perform a weighted average between the previous frame and the current frame of the input depth map based on the variable weight.

For example, the image processing apparatus 100 may perform a weighted average between the current frame and the previous frame through the weighted average application module 430 (in FIG. 4). The image processing apparatus 100 may apply, in the boundary region, a larger weight to the current frame than the previous frame and in the non-boundary region, a larger weight to the previous frame than the current frame by using a variable weight. For example, the image processing apparatus 100 may obtain the first filtered depth map through Equation 5. The image processing apparatus 100 may update the first filtered depth map to the previous frame through Equation 6 and perform first filtering for a next frame. The image processing apparatus 100 may perform first filtering on each frame of the input depth map, thereby generating the first filtered input depth map including a plurality of first filtered frames.

The first filtered depth map may include the boundary region with a high reflection ratio of the current frame and the non-boundary region with a high reflection ratio of the previous frame. That is, the first filtered depth map may have the current frame reflected more significantly in the boundary region and the previous frame reflected more significantly in the non-boundary region.

The image processing apparatus 100 according to an embodiment of the disclosure may perform a weighted average of the current frame and the previous frame to reduce flicker between frames that occurs in a depth map including a moving object. The image processing apparatus 100 may perform a weighted average by using a variable weight having different weights for each boundary region and non-boundary region to reduce a residual image generated in the boundary region of an object during the weighted average.

In operation 1630, the image processing apparatus 100 may generate a 3D image based on the first filtered depth map and the input image.

For example, the image processing apparatus 100 may generate a 3D image through at least one of the binocular viewpoint generation module 340 (in FIG. 3), the hole filling module 350 (in FIG. 3), or the binocular viewpoint combining module 360 (in FIG. 3).

For example, the image processing apparatus 100 may generate a 3D image for left eye and a 3D image for right eye based on the first filtered depth map and the 2D image through the binocular viewpoint generation module 340 (in FIG. 3).

For example, when a hole is generated in a frame as a pixel moves through the hole filling module 350 (in FIG. 3), the image processing apparatus 100 may perform an operation of interpolating the hole by using pixels adjacent to the hole.

For example, the image processing apparatus 100 may generate a 3D image by combining the 3D image for left eye and the 3D image for right eye through the binocular viewpoint combining module 360 (in FIG. 3).

The image processing apparatus 100 according to an embodiment of the disclosure may generate a depth map in which flicker between frames is reduced and a residual image occurring in a boundary region of an object is reduced through first filtering. The image processing apparatus 100 may generate a 3D image by using the first filtered depth map, and thus a 3D effect between frames of the 3D image may be improved.

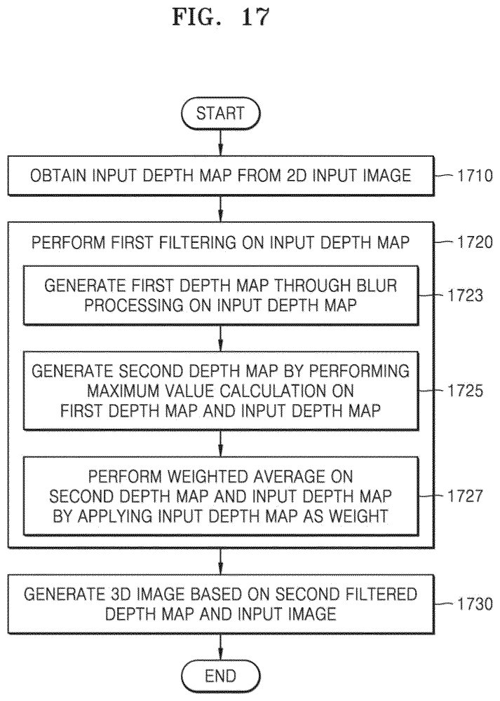

FIG. 17 is a flowchart illustrating a method, performed by an image processing apparatus, of generating a 3D image by performing second filtering on a depth map according to an embodiment of the disclosure. For convenience of explanation, FIG. 16 is explained with reference to FIGS. 10 to 15. In an embodiment of the disclosure, operations 1710 to 1730 may be performed by the image processing apparatus 100 or a processor of the image processing apparatus 100.

In operation 1710, the image processing apparatus 100 may obtain an input depth map from a 2D input image. Operation 1710 may correspond to operation 1610 of FIG. 16.

In operation 1720, the image processing apparatus 100 may perform second filtering on the input depth map.

For example, the image processing apparatus 100 may perform second filtering on the input depth map through the second filtering module 330 (in FIG. 3). The second filtering may implement depth changes inside an object through blur-processing of the foreground region. The second filtering module 330 may generate a depth map to which blur processing is applied differently for the foreground region and the background region, thereby implementing depth changes within the object and distinguishing the boundary between the foreground region and the background region. In more detail, the second filtering may improve a 3D effect inside the object by applying blur processing to the foreground region containing the object. The second filtering may prevent the boundary between the inside of the object (i.e., the foreground region) and the outside of the object (i.e., the background region) from disappearing due to blur processing by not applying blur processing to the background region. Here, the foreground region may represent a region that contains the object (or object of interest) in the depth map. Here, the background region may represent a region other than the object in the depth map.

Operation 1720 may include operations 1723, 1725, and 1727.

In operation 1723, the image processing apparatus 100 may generate a first depth map by performing blur processing on the input depth map.

For example, the image processing apparatus 100 may perform blur processing on an input depth map through the depth map blur processing module 1010 (in FIG. 10). The image processing apparatus 100 may generate the first depth map 1110 (in FIG. 11), which is a blur-processed depth map.

In operation 1725, the image processing apparatus 100 may generate a second depth map by performing maximum value calculation on the first depth map and the input depth map.

For example, the image processing apparatus 100 may perform maximum value calculation on the first depth map and the input depth map through the maximum value calculation module 1020 (in FIG. 10). For example, the image processing apparatus 100 may compare a depth value before blur processing and a depth value after blur processing through Equation 7 and selectively reflect a larger value for each region. For example, in the foreground region, a depth value of the first depth map 1120 may be greater than a depth value of the input depth map 1110. In the background region, a depth value of the input depth map 1110 may be greater than a depth value of the first depth map 1120. Accordingly, the second depth map 1130 (in FIG. 11) may have a foreground region in which the depth value of the first depth map 1120 is reflected and a background region in which the depth value of the input depth map 1110 is reflected. For example, the second depth map 1130 may include the foreground region having a depth value after blur processing and the background region having a depth value before blur processing.

The second depth map 1130 may implement depth changes inside an object through the foreground region having a depth value after blur processing. The second depth map 1130 may distinguish a boundary between the inside and the outside of the object through the background region having a depth value before blur processing.

The depth values for respective regions of the input depth map 1110, the first depth map 1120, and the second depth map 1130 are shown in the graphs 1210 and 1220 of FIG. 12.

In operation 1727, the image processing apparatus 100 may perform a weighted average on the second depth map and the input depth map by applying the input depth map as a weight.

For example, the image processing apparatus 100 may perform a weighted average on the second depth map 1130 and the input depth map 1110 by applying the input depth map 1110 as a weight through the weighted average application module 1330 (in FIG. 13). The input depth map 1110 used as a variable weight may have a large value in the foreground region and a small value in the background region. The image processing apparatus 100 may apply a large weight to the second depth map 1130 in the foreground region and apply a large weight to the input depth map 1110 in the background region.

In the third depth map 1410 (in FIG. 14), which is the second filtered depth map, blur processing may be reflected in the foreground region and blur processing may not be reflected in the background region. Accordingly, when an object other than an object of interest (e.g., another object located behind a human face) is located in the background region, it may be possible to prevent a boundary from disappearing due to blur processing.

In operation 1730, the image processing apparatus 100 may generate a 3D image based on the second filtered depth map and the input image. For example, the image processing apparatus 100 may generate a 3D image for left eye and a 3D image for right eye based on the second filtered depth map and the 2D image through the binocular viewpoint generation module 340 (in FIG. 3). The image processing apparatus 100 may interpolate holes through the hole filling module 350 (in FIG. 3). The image processing apparatus 100 may generate a 3D image by combining the 3D image for left eye and the 3D image for right eye through the binocular viewpoint combining module 360 (in FIG. 3).

The image processing apparatus 100 according to an embodiment of the disclosure may implement a change in depth inside an object through second filtering and generate a depth map in which a boundary between the inside of the object and the outside of the object is distinguished. The image processing apparatus 100 may generate a 3D image by using the second filtered depth map, and thus a 3D effect between object boundaries of the 3D image may be improved.

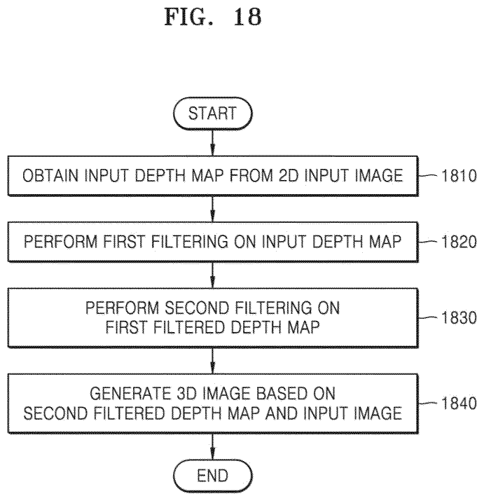

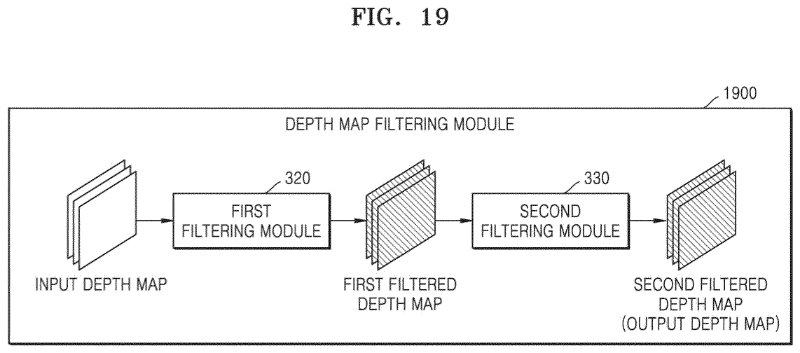

FIG. 18 is a flowchart for explaining an operating method of an image processing apparatus according to an embodiment of the disclosure. FIG. 19 is a diagram for explaining an operation, performed by an image processing apparatus, of filtering an input depth map through a first filtering module and a second filtering module according to an embodiment of the disclosure. In an embodiment of the disclosure, operations 1810 to 1840 may be performed by the image processing apparatus 100 or a processor of the image processing apparatus 100. However, the operating method of the image processing apparatus 100 is not limited to what are shown in FIG. 18, and any one of the operations illustrated in FIG. 18 may be omitted, or additional operations not illustrated in FIG. 18 may be further provided. A depth map filtering module 1900 illustrated in FIG. 19 may be implemented as software, such as instructions, an algorithm, a data structure, or a program code for sequentially applying the first filtering module 320 and the second filtering module 330. The second filtering module 330 illustrated in FIG. 19 may be applied identically to the second filtering module 330 of FIG. 10 or the second filtering module 330a of FIG. 13, except that the depth map input to the second filtering module 330 is a first filtered depth map.

Referring to FIG. 18, in operation 1810, the image processing apparatus 100 may obtain an input depth map from a 2D input image. Operation 1810 may correspond to operation 1610 of FIG. 16.

In operation 1820, the image processing apparatus 100 may perform first filtering on the input depth map.

The image processing apparatus 100 may perform first filtering on an input depth map through the first filtering module 320 to generate the first filtered depth map.

For example, the image processing apparatus 100 may detect the boundary region included in the input depth map through the boundary region detection module 410 (in FIG. 4). For example, the image processing apparatus 100 may generate a variable weight having different values in the boundary region and the non-boundary region through the weight obtaining module 420 (in FIG. 4). For example, the image processing apparatus 100 may perform a weighted average between the previous frame and the current frame of the input depth map based on the variable weight through the weighted average application module 430 (in FIG. 4).

The first filtered depth map may be transferred to the second filtering module 330.

In operation 1830, the image processing apparatus 100 may perform second filtering on the first filtered depth map.

The image processing apparatus 100 may perform second filtering on the first filtered depth map through the second filtering module 330 to generate the second filtered depth map.

For example, the image processing apparatus 100 may perform blur processing on the first filtered depth map through the depth map blur processing module 1010 (in FIG. 10) to generate the first depth map. For example, the image processing apparatus 100 may generate a second depth map by performing optional maximum value calculation on the first depth map and the first filtered depth map through the maximum value calculation module 1020 (in FIG. 10). For example, the image processing apparatus 100 may perform a weighted average on the second depth map and the first filtered depth map by applying the first filtered depth map as a weight through the weighted average application module 1330 (in FIG. 13).

The second filtered depth map may be transferred as an output depth map to the binocular viewpoint generation module 340 (in FIG. 3).

In operation 1840, the image processing apparatus 100 may generate a 3D image based on the second filtered depth map and the input image. The image processing apparatus 100 may generate a 3D image through at least one of the binocular viewpoint generation module 340 (in FIG. 3), the hole filling module 350 (in FIG. 3), or the binocular viewpoint combining module 360 (in FIG. 3).

The image processing apparatus 100 according to an embodiment of the disclosure may generate a depth map in which flicker between frames is reduced and a residual image occurring in a boundary region of an object is reduced through first filtering. The image processing apparatus 100 may generate a 3D image by using the first filtered depth map, and thus a 3D effect between frames of the 3D image may be improved.

The image processing apparatus 100 according to an embodiment of the disclosure may implement a change in depth inside an object through second filtering and generate a depth map in which a boundary between the inside of the object and the outside of the object is distinguished. The image processing apparatus 100 may generate a 3D image by using the second filtered depth map, and thus a 3D effect between object boundaries of the 3D image may be improved.

FIG. 20 is a block diagram of an image processing apparatus according to an embodiment of the disclosure.

Referring to FIG. 20, the image processing apparatus 100 according to an embodiment of the disclosure may include a processor 110, a camera 120, a display 130, and memory 140. However, not all components illustrated in FIG. 20 are required components. The image processing apparatus 100 may be implemented with more components than the components illustrated in FIG. 20 or may be implemented with fewer components. Additionally, each of the components of the image processing apparatus 100 may be configured as internal components, or as external components that are operatively connected to the image processing apparatus.

The processor 110 controls the overall operation of the image processing apparatus 100. For example, the processor 110 may execute one or more instructions stored in the memory 140 to perform a function of the image processing apparatus 100 described in the disclosure. In this case, the memory 140 may store one or more instructions executable by the processor 110. The processor 110 may store one or more instructions in an internally provided memory and execute the one or more instructions stored in the internally provided memory to control the operations described above to be performed. That is, the processor 110 may execute at least one instruction or program stored in the memory provided in the processor 110 or the memory 140 to perform a certain operation.

The processor 110 may be configured with at least one of a central processing unit, a microprocessor, a graphic processing unit, an application processor (AP), application specific integrated circuits (ASICs), digital signal processors (DSPs), digital signal processing devices (DSPDs), programmable logic devices (PLDs), field programmable gate arrays (FPGAs), and a neural processing unit or an artificial intelligence (AI)-dedicated processor designed with a hardware structure specialized for learning and processing an AI model, but is not limited thereto.

The camera 120 may track a user gaze under control of the processor 110. The camera 120 may track eye movement of a user and detect information on the user gaze, such as a direction of the eye of the user and a position of the eye pupils of the user.

The display 130 may display information or images according to received image data under control of the processor 110. For example, the display 130 may display execution screen information of an application program driven by the image processing apparatus 100, or user interface (UI) or graphical user interface (GUI) information according to the execution screen information.

The display 130 may include a 3D display for displaying a 3D image. The display 130 may display the 3D image by using a stereoscopic method, an auto-stereoscopic method, a projection method, a holographic method, or the like. The stereoscopic method is a method of filtering a desired image through polarization-based division, time division, and wavelength division using different wavelengths of primary colors. The auto-stereoscopic method is a method of displaying an image at certain viewpoints in a space by using a 3D optical element such as a parallax barrier, a lenticular lens, or a directional backlight unit. The display 130 may display color images of different viewpoints to the two eyes of the user through the method described above, and the user may perceive a 3D effect of the 3D image.

The memory 140 may store instructions, an algorithm, a data structure, a program code and an application program that are stored for processing and controlling of the processor 110 and store data input to or output from the image processing apparatus 100. The memory 140 may include at least one of a flash memory type, a hard disk type, a multimedia card micro type, a card type memory (for example, an SD or XD memory), random access memory (RAM), static random access memory (SRAM), read-only memory (ROM), electrically erasable programmable read-only memory (EEPROM), programmable read-only memory (PROM), mask ROM, flash ROM, a hard disk drive (HDD), or a solid state drive (SSD). The program (one or more instructions) or application stored in the memory 140 may be executed by the processor 110.

In an embodiment of the disclosure, the memory 140 may store various types of modules to be used to generate a 3D image based on a 2D image. The depth map estimation module 310, the first filtering module 320, the second filtering module 330, the binocular viewpoint generation module 340, the hole filling module 350, and the binocular viewpoint combining module 360 may be stored in the memory 140. The memory 140 may further store the boundary region detection module 410, the weight obtaining module 420, and the weighted average application module 430 that constitute the first filtering module 320. The memory 140 may further store the depth map blur processing module 1010, the maximum value calculation module 1020, and the weighted average application module 1330 that constitute the second filtering module 330. The ‘module’ included in the memory 140 means a unit that processes a function or operation performed by the processor 110 and may be implemented as software such as instructions, an algorithm, a data structure, or a program code.

In an embodiment of the disclosure, the processor 110 may execute one or more instructions included in the depth map estimation module 310 to obtain an input depth map from a 2D input image.

In an embodiment of the disclosure, the processor 110 may execute one or more instructions included in the first filtering module 320 to perform first filtering on the input depth map. The processor 110 may execute the one or more instructions included in the first filtering module 320 to perform a weighted average by using a variable weight having different weights for each boundary region and non-boundary region of the input depth map.

In an embodiment of the disclosure, the processor 110 may execute one or more instructions included in the boundary region detection module 410 to detect a boundary region of an object within the input depth map.

In an embodiment of the disclosure, the processor 110 may execute one or more instructions included in the weight obtaining module 420 to obtain a variable weight having different values for respective regions. The variable weight may have a large value in the boundary region and a small value in the non-boundary region.

In an embodiment of the disclosure, the processor 110 may execute one or more instructions included in the weighted average application module 430 to perform a weighted average between a current frame and a previous frame. The processor 110 may execute one or more instructions included in the weighted average application module 430 to apply a large weight to the current frame in the boundary region and a large weight to the previous frame in the non-boundary region by using the variable weight.

In an embodiment of the disclosure, the processor 110 may execute one or more instructions included in the second filtering module 330 to perform second filtering on the input depth map. The processor 110 may execute one or more instructions included in the second filtering module 330 to generate a depth map in which blur processing is differently applied to the foreground region and the background region.

In an embodiment of the disclosure, the processor 110 may execute one or more instructions included in the depth map blur processing module 1010 to generate a first depth map through blur processing on an input depth map.

In an embodiment of the disclosure, the processor 110 may execute one or more instructions included in the maximum value calculation module 1020 to generate a second depth map by performing maximum value calculation on the first depth map and the input depth map.

In an embodiment of the disclosure, the processor 110 may execute one or more instructions included in the weighted average application module 1330 to perform a weighted average on the second depth map and the input depth map by applying the input depth map as a weight.

In an embodiment of the disclosure, the processor 110 may execute one or more instructions included in the binocular viewpoint generation module 340 to generate a 3D image for left eye and a 3D image for right eye based on the first filtered or second filtered depth map and the 2D image.

In an embodiment of the disclosure, the processor 110 may execute one or more instructions included in the hole filling module 350 to perform an operation of interpolating holes by using pixels adjacent to the holes when holes are generated in a frame as a pixel moves.

In an embodiment of the disclosure, the processor 110 may execute one or more instructions included in the binocular viewpoint combining module 360 to generate a 3D image by combining a 3D image for left eye and a 3D image for right eye.

According to an aspect of the disclosure, an image processing apparatus may include: at least one processor including processing circuitry; and memory including one or more storage media storing one or more instructions, where the at least one processor is configured to, individually or collectively, execute the one or more instructions to cause the image processing apparatus to: obtain an input depth map from a two-dimensional (2D) input image, the input depth map including a boundary region and a non-boundary region of an object. The at least one processor is configured to, individually or collectively, execute the one or more instructions to cause the image processing apparatus to perform first filtering on a first frame and a previous frame of the input depth map to obtain a first filtered depth map, by applying different weights to the boundary region and the non-boundary region. The at least one processor is configured to, individually or collectively, execute the one or more instructions to cause the image processing apparatus to generate a three-dimensional (3D) image, based on the first filtered depth map and the 2D input image.

According to an aspect of the disclosure, in performing the first filtering, the at least one processor may be further configured to, individually or collectively, execute the one or more instructions to cause the image processing apparatus to: detect the boundary region of the input depth map. The at least one processor may be further configured to, individually or collectively, execute the one or more instructions to cause the image processing apparatus to apply a weighted average between the previous frame and the first frame, where, in the boundary region, a larger weight is applied to the first frame than the previous frame, and in the non-boundary region, a larger weight is applied to the previous frame than the first frame.

According to an aspect of the disclosure, in detecting the boundary region of the input depth map, the at least one processor may be further configured to, individually or collectively, execute the one or more instructions to cause the image processing apparatus to: based on the previous frame and the first frame, obtain first depth information including depth values of the boundary region and a background region, based on the previous frame and the first frame, obtain second depth information including depth values of the boundary region and a foreground region, and based on the first depth information and the second depth information, obtain third depth information including a depth value of the boundary region.

According to an aspect of the disclosure, in the performing the first filtering, the at least one processor may be further configured to, individually or collectively, execute the one or more instructions to cause the image processing apparatus to: by scaling the third depth information with a defined slope and limiting an upper limit and a lower limit, obtain a variable weight including a first weight value in the boundary region and a second weight value in the non-boundary region, where the first weight value in the boundary region is larger than the second weight value in the non-boundary region.

According to an aspect of the disclosure, in the boundary region of the first filtered depth map, the first frame may be reflected more than the previous frame, and in the non-boundary region of the first filtered depth map, the previous frame may be reflected more than the first frame.

According to an aspect of the disclosure, the first filtered depth map may include a foreground region and a background region, where the at least one processor is further configured to, individually or collectively, execute the one or more instructions to cause the image processing apparatus to perform second filtering on the first filtered depth map, such that the foreground region of the first filtered depth map is blur-processed differently than the background region of the first filtered depth map.

According to an aspect of the disclosure, in performing the second filtering, the at least one processor may be further configured to, individually or collectively, execute the one or more instructions to cause the image processing apparatus to: generate a first depth map by blur-processing the first filtered depth map, and generate a second depth map including a foreground region corresponding to the first depth map and a background region corresponding to the first filtered depth map, based on a maximum value calculation between the first depth map and the first filtered depth map.

According to an aspect of the disclosure, in the performing the second filtering, the at least one processor may be further configured to, individually or collectively, execute the one or more instructions to cause the image processing apparatus to apply a weighted average between the second depth map and the first filtered depth map, where, in the foreground region, a larger weight is applied to the second depth map than the first filtered depth map, and in the background region, a larger weight is applied to the first filtered depth map than the second depth map.

According to an aspect of the disclosure, in generating the first depth map by blur-processing the first filtered depth map, the at least one processor may be further configured to, individually or collectively, execute the one or more instructions to cause the image processing apparatus to: generate a mipmap as a block unit including a sample pixel referenced for blur processing of a target pixel, and pixels adjacent to the sample pixel, and perform depth map blur processing by using the target pixel and the mipmap.

According to an aspect of the disclosure, in generating the 3D image, the at least one processor may be further configured to, individually or collectively, execute the one or more instructions to cause the image processing apparatus to: generate, based on the first filtered depth map and the 2D input image, a 3D image for a left eye and a 3D image for a right eye, perform hole filling for the 3D image for the left eye and the 3D image for the right eye, and generate a binocular 3D image by combining the 3D image for the left eye and the 3D image for the right eye.

According to an aspect of the disclosure, an operating method of an image processing apparatus may include: obtaining an input depth map from a two-dimensional (2D) input image, the input depth map including a boundary region and a non-boundary region of an object; performing first filtering on a first frame and a previous frame of the input depth map to obtain a first filtered depth map, by applying different weights to the boundary region and the non-boundary region; and generating a three-dimensional (3D) image, based on the first filtered depth map and the 2D input image.

According to an aspect of the disclosure, the performing the first filtering may include: detecting the boundary region of the input depth map; and applying a weighted average between the previous frame and the first frame, where, in the boundary region, a larger weight is applied to the first frame than the previous frame, and in the non-boundary region, a larger weight is applied to the previous frame than the first frame.

According to an aspect of the disclosure, the detecting the boundary region of the input depth map may include: based on the previous frame and the first frame, obtaining first depth information including depth values of the boundary region and a background region; based on the previous frame and the first frame, obtaining second depth information including depth values of the boundary region and a foreground region; and based on the first depth information and the second depth information, obtaining third depth information including a depth value of the boundary region.

According to an aspect of the disclosure, the performing the first filtering may further include, by scaling the third depth information with a defined slope and limiting an upper limit and a lower limit, obtaining a variable weight including a first weight value in the boundary region and a second weight value in the non-boundary region, where the first weight value in the boundary region is greater than the second weight value in the non-boundary region.

According to an aspect of the disclosure, in the boundary region of the first filtered depth map, the first frame may be reflected more than the previous frame, and in the non-boundary region of the first filtered depth map, the previous frame may be reflected more than the first frame.

According to an aspect of the disclosure, the first filtered depth map may include a foreground region and a background region, where the method further includes performing second filtering on the first filtered depth map, such that the foreground region is blur-processed differently than the background region.

According to an aspect of the disclosure, the performing the second filtering may further include: generating a first depth map by blur-processing the first filtered depth map; and generating a second depth map including a foreground region corresponding to the first depth map and a background region corresponding to the first filtered depth map, based on a maximum value calculation between the first depth map and the first filtered depth map.

According to an aspect of the disclosure, the performing the second filtering may further include applying a weighted average between the second depth map and the first filtered depth map, where, in the foreground region, a larger weight is applied to the second depth map than the first filtered depth map, and in the background region, a larger weight is applied to the first filtered depth map than the second depth map.

According to an aspect of the disclosure, the generating the first depth map by blur-processing the first filtered depth map may include: generating a mipmap as a block unit including a sample pixel referenced for blur processing for a target pixel, and pixels adjacent to the sample pixel; and performing depth map blur processing by using the target pixel and the mipmap.

In an embodiment of the disclosure, a computer-readable recording medium having recorded thereon a program for performing the method on a computer may be provided.

A device-readable storage medium may be provided in the form of a non-transitory storage medium. Here, the term ‘non-transitory storage medium’ simply means a tangible device that does not contain a signal (e.g. electromagnetic wave), and the term does not distinguish between cases in which data is stored semi-permanently or temporarily in a storage medium. For example, the ‘non-transitory storage medium’ may include a buffer in which data is temporarily stored.

According to an embodiment, methods according to an embodiment disclosed in the disclosure may be provided as provided in a computer program product. The computer program product may be traded between a seller and a buyer as commodities. The computer program product may be distributed in the form of a machine-readable storage medium (e.g., compact disc read only memory (CD-ROM)), or may be distributed online (e.g., by download or upload) via an application store or directly between two user devices (e.g., smartphones). In the case of online distribution, at least some of computer program products (e.g., a downloadable application) may be temporarily stored or temporarily generated in a device-readable storage medium, such as memory of a server of a manufacturer, a server of an application store, or an intermediary server.

What is claimed is:

1. An image processing apparatus comprising:
at least one processor comprising processing circuitry; and
memory comprising one or more storage media storing one or more instructions,
wherein the at least one processor is configured to, individually or collectively, execute the one or more instructions to cause the image processing apparatus to:
obtain an input depth map from a two-dimensional (2D) input image, the input depth map comprising a boundary region and a non-boundary region of an object,
perform first filtering on a first frame and a previous frame of the input depth map to obtain a first filtered depth map, by applying different weights to the boundary region and the non-boundary region, and
generate a three-dimensional (3D) image, based on the first filtered depth map and the 2D input image.

2. The image processing apparatus of claim 1, wherein, in performing the first filtering, the at least one processor is further configured to, individually or collectively, execute the one or more instructions to cause the image processing apparatus to:
detect the boundary region of the input depth map, and
apply a weighted average between the previous frame and the first frame, and
wherein, in the boundary region, a larger weight is applied to the first frame than the previous frame, and in the non-boundary region, a larger weight is applied to the previous frame than the first frame.

3. The image processing apparatus of claim 2, wherein, in detecting the boundary region of the input depth map, the at least one processor is further configured to, individually or collectively, execute the one or more instructions to cause the image processing apparatus to:
based on the previous frame and the first frame, obtain first depth information comprising depth values of the boundary region and a background region,
based on the previous frame and the first frame, obtain second depth information comprising depth values of the boundary region and a foreground region, and
based on the first depth information and the second depth information, obtain third depth information comprising a depth value of the boundary region.

4. The image processing apparatus of claim 3, wherein, in the performing the first filtering, the at least one processor is further configured to, individually or collectively, execute the one or more instructions to cause the image processing apparatus to:
by scaling the third depth information with a defined slope and limiting an upper limit and a lower limit, obtain a variable weight comprising a first weight value in the boundary region and a second weight value in the non-boundary region, and
wherein the first weight value in the boundary region is larger than the second weight value in the non-boundary region.

5. The image processing apparatus of claim 1, wherein, in the boundary region of the first filtered depth map, the first frame is reflected more than the previous frame, and in the non-boundary region of the first filtered depth map, the previous frame is reflected more than the first frame.

6. The image processing apparatus of claim 1, wherein the first filtered depth map comprises a foreground region and a background region, and
wherein the at least one processor is further configured to, individually or collectively, execute the one or more instructions to cause the image processing apparatus to perform second filtering on the first filtered depth map, such that the foreground region of the first filtered depth map is blur-processed differently than the background region of the first filtered depth map.

7. The image processing apparatus of claim 6, wherein, in performing the second filtering, the at least one processor is further configured to, individually or collectively, execute the one or more instructions to cause the image processing apparatus to:
generate a first depth map by blur-processing the first filtered depth map, and
generate a second depth map comprising a foreground region corresponding to the first depth map and a background region corresponding to the first filtered depth map, based on a maximum value calculation between the first depth map and the first filtered depth map.

8. The image processing apparatus of claim 7, wherein, in the performing the second filtering, the at least one processor is further configured to, individually or collectively, execute the one or more instructions to cause the image processing apparatus to apply a weighted average between the second depth map and the first filtered depth map, and
wherein, in the foreground region, a larger weight is applied to the second depth map than the first filtered depth map, and in the background region, a larger weight is applied to the first filtered depth map than the second depth map.

9. The image processing apparatus of claim 7, wherein, in generating the first depth map by blur-processing the first filtered depth map, the at least one processor is further configured to, individually or collectively, execute the one or more instructions to cause the image processing apparatus to:
generate a mipmap as a block unit comprising a sample pixel referenced for blur processing of a target pixel, and pixels adjacent to the sample pixel, and
perform depth map blur processing by using the target pixel and the mipmap.

10. The image processing apparatus of claim 1, wherein, in generating the 3D image, the at least one processor is further configured to, individually or collectively, execute the one or more instructions to cause the image processing apparatus to:
generate, based on the first filtered depth map and the 2D input image, a 3D image for a left eye and a 3D image for a right eye,
perform hole filling for the 3D image for the left eye and the 3D image for the right eye, and
generate a binocular 3D image by combining the 3D image for the left eye and the 3D image for the right eye.

11. An operating method of an image processing apparatus, the operating method comprising:
obtaining an input depth map from a two-dimensional (2D) input image, the input depth map including a boundary region and a non-boundary region of an object;
performing first filtering on a first frame and a previous frame of the input depth map to obtain a first filtered depth map, by applying different weights to the boundary region and the non-boundary region; and
generating a three-dimensional (3D) image, based on the first filtered depth map and the 2D input image.

12. The operating method of claim 11, wherein the performing the first filtering comprises:
detecting the boundary region of the input depth map; and
applying a weighted average between the previous frame and the first frame, and
wherein, in the boundary region, a larger weight is applied to the first frame than the previous frame, and in the non-boundary region, a larger weight is applied to the previous frame than the first frame.

13. The operating method of claim 12, wherein the detecting the boundary region of the input depth map comprises:
based on the previous frame and the first frame, obtaining first depth information including depth values of the boundary region and a background region;
based on the previous frame and the first frame, obtaining second depth information including depth values of the boundary region and a foreground region; and
based on the first depth information and the second depth information, obtaining third depth information including a depth value of the boundary region.

14. The operating method of claim 13, wherein the performing the first filtering further comprises, by scaling the third depth information with a defined slope and limiting an upper limit and a lower limit, obtaining a variable weight including a first weight value in the boundary region and a second weight value in the non-boundary region, and
wherein the first weight value in the boundary region is greater than the second weight value in the non-boundary region.

15. The operating method of claim 11, wherein, in the boundary region of the first filtered depth map, the first frame is reflected more than the previous frame, and in the non-boundary region of the first filtered depth map, the previous frame is reflected more than the first frame.

16. The operating method of claim 11, wherein the first filtered depth map comprises a foreground region and a background region, and
wherein the method further comprises performing second filtering on the first filtered depth map, such that the foreground region is blur-processed differently than the background region.

17. The operating method of claim 16, wherein the performing the second filtering further comprises:
generating a first depth map by blur-processing the first filtered depth map; and
generating a second depth map including a foreground region corresponding to the first depth map and a background region corresponding to the first filtered depth map, based on a maximum value calculation between the first depth map and the first filtered depth map.

18. The operating method of claim 17, wherein the performing the second filtering further comprises applying a weighted average between the second depth map and the first filtered depth map, and
wherein, in the foreground region, a larger weight is applied to the second depth map than the first filtered depth map, and in the background region, a larger weight is applied to the first filtered depth map than the second depth map.

19. The operating method of claim 17, wherein the generating the first depth map by blur-processing the first filtered depth map comprises:
generating a mipmap as a block unit including a sample pixel referenced for blur processing for a target pixel, and pixels adjacent to the sample pixel; and
performing depth map blur processing by using the target pixel and the mipmap.

20. A non-transitory computer-readable recording medium having recorded thereon a program for performing the operating method of claim 11 on a computer.
